(19) United States
(12) Patent Application Publication
(10) Pub. No.: US 2004/0170766 A1
(43) Pub. Date: Sep. 2, 2004

(54) Electroless plating method and device, and substrate processing method and apparatus

(76) Inventors: Hiroaki Inoue, Tokyo (JP); Norio Kimura, Kanagawa (JP); Kenji Nakamura, Kanagawa (JP); Moriji Matsumoto, Kanagawa (JP)

Correspondence Address: WENDEROTH, LIND & PONACK, L.L.P., 2033 K STREET N. W., SUITE 800, WASHINGTON, DC, 20006-1021, US

(21) Appl. No.: 10/476,698

(22) PCT Filed: May 9, 2002
(86) PCT No.: PCT/JP02/04522

(30) Foreign Application Priority Data
May 10, 2001 (JP) 2001-140606
May 18, 2001 (JP) 2001-150080

(51) Int. Cl. B05D 3/12

(52) U.S. Cl. 427/355; 118/300; 118/320; 427/443.1

(57) ABSTRACT

There is provided an electroless plating method and device which can form a plated film having an improved uniformity of film thickness with an enhanced selectivity, while preventing the formation of fine pores in the plated film. The electroless plating method comprises, bringing a substrate into contact with an electroless plating solution to form a plated film on the surface of the substrate, and scrubbing the surface of the plated film formed or being formed on the surface of the substrate.

### TECHNICAL FIELD

This invention relates to an eletroless plating method and device, and also to a substrate processing method and apparatus. More particularly, this invention relates to an electroless plating method and device useful for forming a protective film for protecting the surface of the interconnects of an electronic device which has such an embedded interconnect structure that an electric conductor, such as silver or copper, is embedded into fine recesses for interconnects formed in the surface of a substrate such as a semiconductor substrate. This invention also relates to a substrate processing method and apparatus useful for forming a plated film on such a substrate as a semiconductor wafer that requires a high flatness and cleanness.

### BACKGROUND ART

As a process for forming interconnects in an electronic device, the so-called “damascene process”, which comprises filling trenches for interconnects and contact holes with a metal (electric conductor), coming into practical use. According to this process, aluminum, or more recently a metal such as silver or copper, is embedded into trenches for interconnects and contact holes previously formed in the interlevel dielectric of a semiconductor substrate. Thereafter, an extra metal is removed by chemical mechanical polishing (CMP) so as to flatten the surface of the substrate.

In recent years, instead of using aluminum or aluminum alloys as a material for forming interconnection circuits on a semiconductor substrate, there is an eminent movement towards using copper (Cu) which has a low electric resistance and high electromigration resistance. Copper interconnects are generally formed by filling fine recesses formed in the surface of a substrate with copper. There are known various techniques for producing such copper interconnects, including CVD, sputtering, and plating. According to any such technique, a copper film is formed in the substantially entire surface of a substrate, followed by removal of unnecessary copper by CMP.

In the case of interconnects formed by such a process, the embedded interconnects have an exposed surface after the flattening processing. When an additional embedded interconnect structure is formed on such an exposed surface of the interconnects of a semiconductor substrate, the following problems may be encountered. For example, during the formation of a new SiO₂ interlevel dielectric, the exposed surface of the pre-formed interconnects is likely to be oxidized. Further, upon etching of the SiO₂ layer for the formation of contact holes, the pre-formed interconnects exposed at the bottoms of the contact holes can be contaminated with an etchant, a peeled resist, etc. Moreover, in the case copper interconnects, there is a fear of copper diffusion.

In order to avoid such problems, it has conventionally been practiced to form a protective film of SiN or the like not only on the interconnect region of a semiconductor substrate where the interconnects are exposed, but on the entire surface of the substrate, thereby preventing the contamination of the exposed interconnects with an etchant, etc.

However, the provision of a protective film of SiN or the like on the entire surface of a semiconductor substrate, in an electronic device having an embedded interconnect structure, increase the dielectric constant of the interlevel dielectric, thus inducing delayed interconnection even when a low-resistance material such as silver or copper is employed as an interconnect material, whereby the performance of the electronic device may be impaired.

In views of this, it may be considered to selectively cover the surface of the exposed interconnects with a protective film, such as a Ni—B alloy film, having a good adhesion to an interconnect material such as silver or copper and having a low resistivity (ρ). The Ni—B alloy film can be formed selectively on the surface of copper or the like by carrying out electroless plating, using an electroless plating solution containing nickel ions, a complexing agent for nickel ions, an alkylamine borane or a hydrogen boride compound as a reducing agent for nickel ions, etc.

The electroless plating, however, inevitably involves generation of H₂ gas in the course of film formation. The H₂ gas, when taken in the plated film and blew out, can leave the traces of the gas blow-out, which may be in the form of fine pores, in the protective film (plated film) that selectively covers and protects interconnects. When such fine pores, penetrating the protective film (plated film) of Ni—B alloy or the like in the thickness direction, are formed in the protective film that covers the surface of e.g. copper interconnects, the surface of copper becomes exposed, which may cause problems such as copper diffusion. This means that the plated film of Ni—B alloy or the like cannot properly function as a protective film. Further, the protective film (plated film) of Ni—B alloy film or the like, which has been formed by electroless plating selectively on the surface of copper or the like, is generally poor in the uniformity within the substrate of film thickness, i.e. the thickness varying widely in the same film, and also poor in the selectivity.

In addition, in the case of copper interconnects, there is a difference in the depth of oxidized layer between the copper surface immediately after a CMP treatment and the copper surface after a lapse of time from the CMP treatment. Accordingly, when a protective film is formed to protect the surface of copper interconnects, the state of the protective film can differ depending upon the period of time between a CMP treatment and the film formation; there is a case in which a stable protective film cannot be formed.

### DISCLOSURE OF INVENTION

The present invention has been made in view of the above situation in the related art. It is therefore an object of the present invention to provide an electroless plating method and device which can form a plated film having an improved uniformity within the substrate of film thickness with an enhanced selectivity, while preventing the formation of fine pores in the plated film. The present invention also provide a substrate processing method and apparatus which enables the protection of the polished surface of interconnects with a protective film in a more stable state.

In order to achieve the above object, the present invention provides an electroless plating method comprising: bringing a substrate into contact with an electroless plating solution to form a plated film on a surface of the substrate; and scrubbing the surface of the plated film formed or being formed on the surface of the substrate.

By thus scrubbing the surface of the plated film in the course of the growth of the film, H₂ gas generated upon the film formation is forced to be expelled, whereby the H₂ gas is prevented from being taken in the plated film. Further, uniformity of the diffusion layer of the plating solution present in the vicinity of the surface of the substrate can be improved, whereby the uniformity within the substrate of film thickness of the plated film can be improved. Moreover, by removing such a portion of the plated film that has a low adhesion, the selectivity can be enhanced. The scrubbing of the surface of the plated film may also be carried out independent of the electroless plating.

In a preferred embodiment, the substrate is brought into contact with the electroless plating solution to form a plated film on the surface of the substrate while the surface of the plated film being formed on the surface of the substrate is scrubbed.

In another preferred embodiment, the substrate is brought into contact with the electroless plating solution to form an initial plated film, and the electroless plating is continued to deposit a plated film on the initial plated film while the surface of the plated film is being scrubbed.

According to this embodiment, the electroless plating is first carried out e.g. for at least 0.001 minute, preferably 0.5 minute without scrubbing the surface of the plated film being formed, thereby forming the initial plated film, and the electroless plating is continued while the surface of the film is being scrubbed. This manner of electroless plating can prevent the growth of the initial plated film from being stunted.

The present invention also provides a electroless plating method, comprising: bringing a substrate into contact with an electroless plating solution to form a plated film on a surface of the substrate; scrubbing the surface of the plated film formed on the surface of the substrate; and repeating the bringing and the scrubbing.

In still another preferred embodiment, the scrubbing the surface of the plated film may be carried out by means of a scrubbing member. It is not necessary to incessantly scrub the plated film. Thus, it will be sufficient to reciprocate e.g. a roll-type scrubbing member e.g. at a rate of one reciprocation in 15 seconds.

Alternatively, the scrubbing may be carried out by crashing a fluid into the surface of the plated film. The scrubbing may also be carried out by crashing particles mixed in a fluid into the surface of the plated film.

The present invention also provides an electroless plating device, comprising: a substrate holder for detachably holding a substrate and bringing the substrate into contact with an electroless plating solution; and means for scrubbing the surface of the substrate which is held by the substrate holder and is in contact with the electroless plating solution.

In the above device, the means for scrubbing the surface of the substrate may be a scrubbing member. In this case, the device may further comprise a moving mechanism for relatively moving the scrubbing member and the substrate holder.

The present invention also provides a substrate processing method comprising the steps of: polishing a surface of a substrate; and electroless plating the polished surface of the substrate immediately after the polishing step.

By thus carrying out electroless plating of the surface of a substrate immediately after polishing the surface of the substrate by means of e.g. CMP to flatten the surface, a stable protective film (plated film) can be obtained and the surface of the substrate can be protected stably with the protective film. Further, the employment of electroless plating can provide a protective film in a simplified manner compared to electrolytic plating, sputtering or CVD. The substrate processing method may further include a cleaning step between the polishing step and the electroless plating step.

The present invention further provides a substrate processing apparatus, comprising: a polishing device for polishing a surface of a substrate; and an electroless plating device for carrying out electroless plating to selectively form a plated film as a protective film on the polished surface of the substrate.

According to the apparatus, the polishing in the polishing device for flattening the surface of a substrate and the electroless plating for forming the protective film on the polished surface of the substrate can be carried out successively.

The apparatus may further comprise an etching device for etching the surface of the substrate.

The electroless plating device used in the apparatus may preferably be the above-described one.

The present invention also provides a substrate having a plated film, the plated film having been formed by a process comprising bringing a substrate into contact with an electroless plating solution to form a plated film while the surface of the plated film formed or being formed on a surface of the substrate is being scrubbed.

The above and other objects, features, and advantages of the present invention will be apparent from the following description when taken in conjunction with the accompanying drawings which illustrate preferred embodiments of the present invention by way of example.

### BRIEF DESCRIPTION OF DRAWINGS

FIGS. 1A through 1C are diagrams illustrating, in sequence of process steps, an example of the formation of copper interconnects in an electronic device;

FIG. 2 is a plan view showing the layout of a substrate processing apparatus according to an embodiment of the present invention;

FIG. 3 is a cross-sectional view of a polishing device as provided in the apparatus of FIG. 2;

FIG. 4 is a cross-sectional view of an electroless plating device according to an embodiment of the present invention, which is provided in the apparatus of FIG. 2;

FIG. 5 is a plan view of the substrate holder and the swingable arm of FIG. 4;

FIG. 6 is a cross-sectional view of an electroless plating device according to another embodiment of the present invention;

FIG. 7 is a cross-sectional view of an electroless plating device according to still another embodiment of the present invention;

FIG. 8 is a cross-sectional view of an electroless plating device according to still another embodiment of the present invention;

FIGS. 9A and 9B are diagrams of SEM photographs of the plated substrates obtained in Example 1 (sample according to the present invention and comparative sample, respectively);

FIGS. 10A and 10B are diagrams of SEM photographs of the plated substrates obtained in Example 2 (sample according to the present invention and comparative sample, respectively);

FIG. 11 is a plan view showing the layout of a substrate process apparatus according to another embodiment of the present invention;

FIG. 12 is a plan view of an example of a substrate plating apparatus;

FIG. 13 is a schematic view showing airflow in the substrate plating apparatus shown in FIG. 12;

FIG. 14 is a cross-sectional view showing airflows among areas in the substrate plating apparatus shown in FIG. 12;

FIG. 15 is a perspective view of the substrate plating apparatus shown in FIG. 12, which is placed in a clean room;

FIG. 16 is a plan view of another example of a substrate plating apparatus;

FIG. 17 is a plan view of still another example of a substrate plating apparatus;

FIG. 18 is a plan view of still another example of a substrate plating apparatus;

FIG. 19 is a view showing a plan constitution example of the semiconductor substrate processing apparatus;

FIG. 20 is a view showing another plan constitution example of the semiconductor substrate processing apparatus;

FIG. 21 is a view showing still another plan constitution example of the semiconductor substrate processing apparatus;

FIG. 22 is a view showing still another plan constitution example of the semiconductor substrate processing apparatus;

FIG. 23 is a view showing still another plan constitution example of the semiconductor substrate processing apparatus;

FIG. 24 is a view showing still another plan constitution example of the semiconductor substrate processing apparatus;

FIG. 25 is a view showing a flow of the respective steps in the semiconductor substrate processing apparatus illustrated in FIG. 24;

FIG. 26 is a view showing a schematic constitution example of a bevel and backside cleaning unit;

FIG. 27 is a vertical sectional view of an example of an annealing unit; and

FIG. 28 is a transverse sectional view of the annealing unit.

### BEST MODE FOR CARRYING OUT THE INVENTION

Preferred embodiments of the present invention will now be described with reference to the drawings.

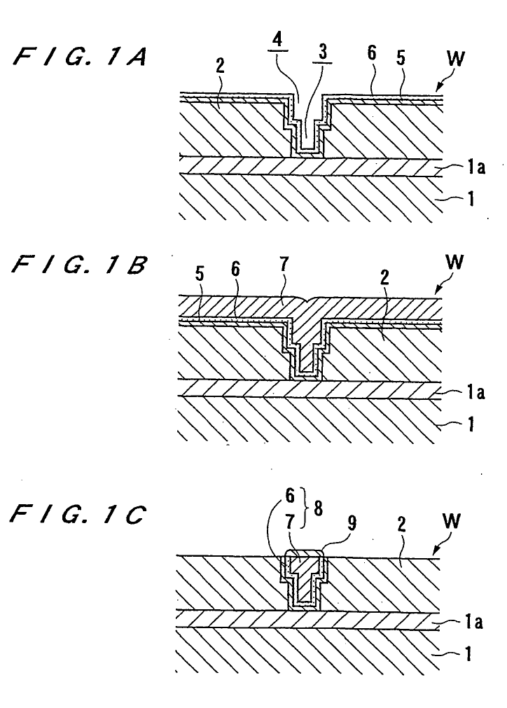

FIGS. 1A through 1C illustrate, in sequence of process steps, an example of the formation of copper interconnects in an electronic device. As shown in FIG. 1A, an insulating film 2 of SiO₂ is deposited on a conductive layer 1a in which electronic devices are formed, which is formed on an electronic device base 1. Contact holes 3 and trenches 4 for interconnects are formed in the insulating film 2 by the lithography/etching technique. Thereafter, a barrier layer 5 of TaN or the like is formed on the entire surface, and a copper seed layer 6 as an electric supply layer for electroplating is formed on the barrier layer 5.

Thereafter, as shown in FIG. 1B, copper plating is carried out onto the surface of the electronic device substrate W to fill the contact holes 3 and the trenches 4 with copper and, at the same time, deposit a copper layer 7 on the insulating film 2. Thereafter, the copper layer 7 and the barrier layer 5 on the insulating film 2 are removed by chemical mechanical polishing (CMP) so as to make the surface of the copper layer 7 filled in the contact holes 3 and the trenches 4 for interconnects and the surface of the insulating film 2 lie substantially on the same plane. Interconnects 8 composed of the copper seed layer 6 and the copper layer 7, as shown in FIG. 1C, are thus formed in the insulating layer 2. Next, electroless Ni—B plating is carried out to the surface of the substrate W to form a protective film (plated film) 9 composed of a Ni—B alloy selectively on the exposed surface of the interconnects 8 to protect the interconnects 8.

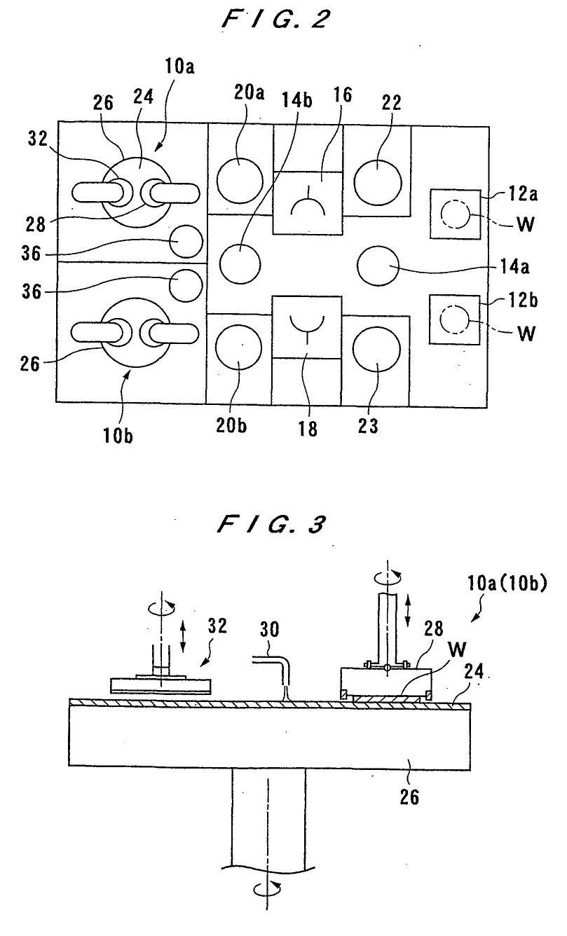

FIG. 2 is a plan view showing the layout of a substrate processing apparatus according to one embodiment of the present invention. The substrate processing apparatus includes, at one end of the space on a rectangular floor, a pair of polishing devices 10a and 10b disposed opposite to each other, and, at the other end, a pair of loading/unloading sections for placing thereon cassettes 12a and 12b for housing substrates W such as semiconductor wafers. Two transfer robots 14a and 14b are provided on a transfer line bridging the polishing devices 10a, 10b and the loading/unloading sections. On the opposite sides of the transfer line are provided a dry substrate-reversing machine 16 and a wet substrate-reversing machine 18. On the opposite sides of the dry substrate-reversing machine 16, a first cleaning device 20a and a second cleaning device 22 are provided, and on the opposite sides of the wet substrate-reversing machine 18, a first cleaning device 20b and an electroless plating device 23 are provided. Vertically-movable pushers 36 are provided near the polishing devices 10a and 10b on the transfer line sides thereof for transferring the substrate W between them and the polishing devices 10a and 10b.

FIG. 3 shows the polishing devices 10a and 10b provided in the substrate processing apparatus shown in FIG. 2. The polishing devices 10a and 10b each comprise a polishing table 26 having a polishing surface composed of a polishing cloth (polishing pad) 24 which is attached to the upper surface of the polishing table 26, and a top ring 28 for holding a substrate W with its surface, to be polished, facing the polishing table 26. Polishing of the surface of the substrate W is carried out by rotating the polishing table 26 and the top ring 28 respectively, and supplying an abrasive liquid from an abrasive liquid nozzle 30 provided above the polishing table 26 while pressing the substrate W against the polishing cloth 24 of the polishing table 26 at a given pressure by the top ring 28. As the abrasive liquid supplied from the abrasive liquid nozzle 30, a suspension of abrasive particles, such as fine particles of silica, in an acidic solution may be used. By oxidizing the surface of the substrate, followed by mechanical polishing by means of abrasive particles, the substrate W can be polished into a flat mirror surface.

The polishing power of the polishing surface of the polishing cloth 24 decreases with a continuous polishing operation by the polishing device 10a or 10b. In order to restore the polishing power, a dresser 32 is provided to conduct dressing of the polishing cloth 24, for example, at the time of changing the substrate W. In the dressing treatment, while rotating the dresser 32 and the polishing table 26 respectively, the dressing surface (dressing member) of the dresser 32 is pressed against the polishing cloth 24 of the polishing table 26, thereby removing the abrasive liquid and chips adhering to the polishing surface and, at the same time, flattening and dressing the polishing surface, whereby the polishing surface is regenerated. The dressing may be carried out during the polishing treatment.

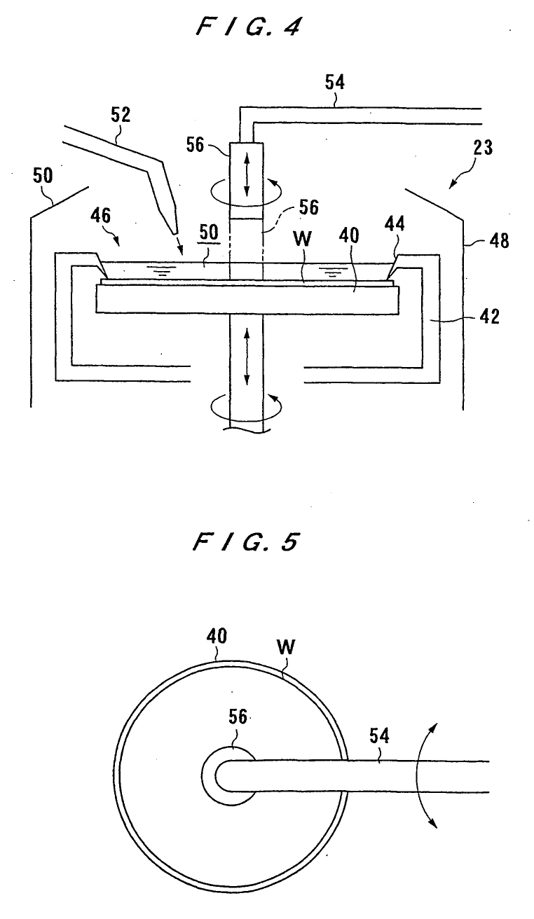

FIGS. 4 and 5 show an electroless plating device 23 according to an embodiment of the present invention, which is provided in the substrate processing apparatus shown in FIG. 2. The electroless plating device 23 includes a rotatable, vertically-movable substrate holder 40 for absorbing and holding a substrate W with its front surface upward, and a rotatable housing 42 that surrounds the substrate holder 40. At the upper end of the housing 42 is provided a seal ring 44 composed of an elastic material that extends inwardly and then downwardly. When the substrate holder 40 holding the substrate W is elevated so as to bring the peripheral portion of the upper surface (front surface) of the substrate W into pressure contact with the seal ring 44 to seal the peripheral portion of the substrate W, a top-opened plating bath 46, defined by the upper surface of the substrate W and by the seal ring 44, is formed, and the housing 42 becomes able to rotate together with the substrate holder 40 when the substrate holder 40 is rotated. Further, a scattering-prevention cover 48 for preventing scattering of a plating solution (electroless plating solution) 50 is provided around the housing 42.

Positioned above the housing 42, there are provided a plating solution supply nozzle 52 for supplying the plating solution (electroless plating solution) 50 into the plating bath 46 defined by the upper surface of the substrate W and the seal ring 44, and a swingable arm 54 that can swing horizontally and move vertically. A cylindrical scrubbing member 56 is rotatably supported on the free end of the swingable arm 54 and extends downwardly therefrom.

The scrubbing member 56 is composed of a material softer than the to-be-scrubbed material, such as PVA, a sponge or a resin. Accordingly, when the scrubbing member 56 scrubs the surface of the substrate W, the surface of the protective film 9 and the surface of the insulating film 2, shown in FIG. 1C, can be prevented from being damaged by the scrubbing member 56. The effect of the scrubbing, which will be described in detail below, is basically brought about by application of a physical force to the diffusion layer of a plating solution in the vicinity of the surface of the substrate and to the hydrogen gas generated, without any damage to the surface of the substrate. Thus, besides the use of PVA, a sponge, etc., other scrubbing means for the application of physical force, such as collision of a fluid or of particles mixed in a fluid against the surface of the substrate, may produce the same technical effect. The scrubbing member and the arm that supports the scrubbing member may each be in any shape insofar as the surface of the substrate W can be scrubbed properly. A roller-type scrubbing member, for example, can be employed.

Though not figured, there are provided above the housing 42 a swivelable, vertically-movable plating solution recovery nozzle for sucking and recovering the plating solution in the plating bath 46, and a cleaning nozzle for supplying a cleaning liquid, such as ultrapure water, to the surface of the substrate W after the plating.

In operation, the substrate holder 40 holding the substrate W is elevated so that the substrate holder 40, together with the seal ring 44, forms the plating bath 46. Thereafter, the plating solution 50 is supplied from the plating solution supply nozzle 52 into the plating bath 46 and, according to necessity, the substrate holder 40 is rotated, thereby carrying out electroless plating of the surface of the substrate W. On the other hand, the swingable arm 54 is lowered so as to bring the scrubbing member 56, which is supported on the free end of the arm 54, into contact with the surface of the substrate W. While the scrubbing member 56 is being rotated, the swingable arm 54 is swung horizontally and, at the same time, the substrate holder 40 is rotated, whereby the surface of the substrate W can be scrubbed by the scrubbing member 56 over the entire surface.

A description will now be given of a series of treatments as preformed by the substrate processing apparatus, the treatments comprising polishing the surface of a substrate W as shown in FIG. 1B that has the copper layer 7 formed thereon, and electroless plating the polished surface of the substrate to deposit the protective film (plated film) 9 selectively on the surface of the copper interconnects 8 (see FIG. 1C). In the substrate processing apparatus, the two polishing devices 10a and 10b perform the same treatment in parallel, and therefore the flow of the substrate W is the same in the polishing devices 10a and 10b. Accordingly, the description will be made for one of the polishing devices.

The substrate W is taken out of the cassette 12a (12b) by the first robot 14a and transferred to the dry substrate-reversing machine 16, where the substrate is reversed, and the substrate W is then transferred by the second robot 14b to the pusher 36. Thereafter, the top ring 28 swings to come to a position over the pusher 36, and absorbs and holds the substrate W, and then moves to a position above the polishing table 26. The top ring 28 is then lowered so as to press the to-be-polished surface of the substrate W against the polishing close 24 (see FIG. 3) of the rotating polishing table 26 at a given pressure, while the abrasive liquid is supplied onto the substrate W, thereby carrying out polishing of the surface of the substrate W.

In the case of polishing a copper layer formed on the substrate W, a slurry for exclusive use for Cu-plating is preferably used as the abrasive liquid. When the surface of the substrate, to be polished, has irregularities, it is known to be effective to carry out polishing under the conditions of a relative low pressure and a relatively high rotational speed. Such polishing, however, involves a lowering of the processing rate. It may, therefore, be considered to carry out a multi-step polishing, for example a two-step polishing comprising: a first polishing carried out at a top ring pressure of e.g. 40 kPa and a top ring rotating speed of e.g. 70 min⁻¹ for a certain time; and a second polishing carried out at a top ring pressure of e.g. 20 kPa and a top ring rotating speed of 50 min⁻¹ for a certain time. Such a multi-step polishing may achieve flattening of the surface of the substrate with a good total efficiency.

The polished substrate W is returned by the top ring 28 onto the pusher 36, where the substrate is cleaned with a spray of pure water. The substrate W is then transferred by the second robot 14b to the first cleaning device 20a for carrying out a first cleaning of the substrate, and the cleaned substrate is taken by the first robot 14a and transferred to the electroless plating device 23. In the electroless plating device 23, electroless Ni—B plating, for example, is carried out onto the polished surface of the substrate W to thereby form, as shown in FIG. 1C, the protective film (plated film) 9 of a Ni—B alloy selectively on the exposed surface of copper interconnects 8 to protect the interconnects 8. The thickness of the protective film 9 is generally 0.1 to 500 nm, preferably 1 to 200 nm, more preferably 10 to 100 nm.

The plating solution 50 for forming the protective film 9 may be an electroless Ni—B plating solution which contains nickel ions, a complexing agent for nickel ions, and an alkylamine borane or a hydrogen boride as a reducing agent for nickel ions, and which is adjusted at a pH of 5 to 12 by using TMAH (tetramethylammonium hydroxide) as a pH adjusting agent.

The provision of protective film 9 for the protection of interconnects 8 can prevent the surface oxidation of the interconnects 8 upon the formation of a SiO₂ interlevel dielectric in the next processing step for the formation of an additional embedded interconnect structure, for example. The contamination of the interconnects with an etchant, a peeled resist, etc. upon etching of the SiO₂ layer can also be prevented. Further, by selectively covering the surface of the interconnects 8 and protecting the interconnects 8 with the protective film 9 of a Ni—B alloy that has a high adhesion to copper and has a low resistivity (ρ), an increase in the dielectric constant of the interlevel dielectric of an electronic device having an embedded interconnect structure can be suppressed. In addition, the use as an interconnect material of copper, which is a low-resistance material, contributes to speedup and densification of the electronic device.

When a protective film 9 having a thickness of 110 nm, for example, is to be formed e.g. in two minutes, the electroless plating may be carried out in the following manner:

First, the substrate holder 40 holding the substrate W is elevated so that the substrate holder 40, together with the seal ring 44, forms the plating bath 46. Thereafter, the plating solution 50 is supplied from the plating solution supply nozzle 52 into the plating bath 46 and, according to necessity, the substrate holder 40 is rotated. Electroless plating is thus carried out e.g. for 0.5 minute, thereby forming an initial plated film on the surface of the substrate W. Thereafter, the swingable arm 54 is lowered so as to bring the scrubbing member 56, which is supported on the free end of the arm 54, into contact with the surface of the substrate W. While rotating the scrubbing member 56, the swingable arm 54 is swung horizontally and, at the same time, the substrate holder 40 is rotated, thereby scrubbing the entire surface of the substrate W with the scrubbing member 56. The scrubbing operation may be carried out e.g. for 1.5 minutes by reciprocating the scrubbing member 56 e.g. at a rate of one reciprocation in 15 seconds.

By thus scrubbing the surface of the plated film with the scrubbing member 56 in the course of the growth of the film, H₂ gas generated upon the film formation is forced to be expelled, whereby the H₂ gas is prevented from being taken in the plated film. Accordingly, the formation of fine pores in the plated film, which is caused by blow-out of H₂ gas taken in the plated film, can be prevented. Further, by stirring with the scrubbing member 56 the plating solution 50 present in the vicinity of the surface of the substrate W, uniformity of the diffusion layer of the plating solution 50 can be improved, whereby the uniformity within the substrate of film thickness of the plated film can be improved. Moreover, by scrubbing the plated film with the scrubbing member 56, such a portion of the plated film that has a low adhesion, i.e. the portion of the plated film adhering to the unnecessary (non-interconnect) portion of the surface of the substrate, can be removed whereby the selectivity can be enhanced.

Further, by carrying out the electroless plating of the surface of the substrate W immediately after polishing the surface of the substrate W by the CMP device 10a to flatten the surface, i.e. when the copper interconnects 8 (see FIG. 1C) is little oxidized, the protective film (plated film) 9 in a stable state (good adhesion to the interconnects) can be obtained and the surface of the substrate W can be protected stably with the protective film 9.

When the electroless plating is carried out in a manner in which electroless plating of the surface of the substrate W is first carried out e.g. for at least 0.001 minute, preferably 0.5 minute without scrubbing the surface of the substrate W to grow an initial plated film, and thereafter, i.e. when gas bubbles begin to form, the surface of a plated film being deposited onto the initial film is scrubbed with the scrubbing member 56, the growth of the initial plated film can be prevented from being stunted by the presence of the scrubbing member 56.

After the completion of electroless plating, the substrate W is spin-dried by rotating the substrate at a high speed. Thereafter, the substrate W is taken out of the substrate holder 40, and transferred to the second cleaning device 22 for carrying out a second cleaning and a high-speed spin-drying of the substrate W. Thereafter, the substrate W is returned by the first robot 14a to the cassette 12a (12b).

Though the above-described embodiment uses copper as an interconnect material, it is possible to use a copper alloy, silver, a silver alloy, etc. instead of copper.

Further, though the case of forming a plated film while scrubbing a growing film has been shown, it is possible to carry out the step of forming a plated film and the step of scrubbing the surface of the plated film separately. Thus, the substrate having a plated film which has grown to some extent may be taken out of the plating bath, and the surface of the plated film may be scrubbed. This process is to be repeated.

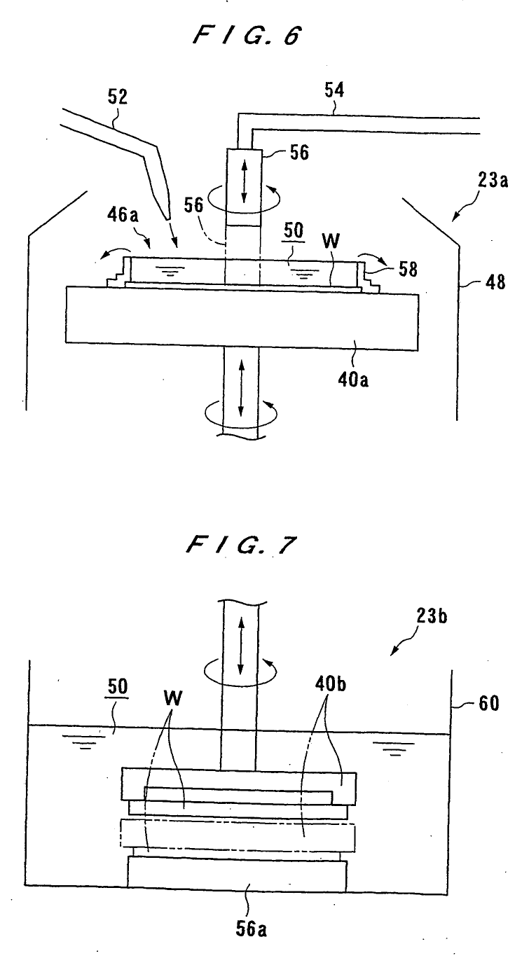

FIG. 6 shows an electroless plating device 23a according to another embodiment of the present invention. The electroless plating device 23a includes a rotatable, vertically-movable substrate holder 40a for holding the substrate W thereon, and a dam member 58 for contacting the peripheral portion of the upper surface of the substrate W held by the substrate holder 40a to thereby seal the peripheral portion of the substrate W and forming, together with the upper surface of the substrate W, a plating bath 46a. The substrate holder 40a is allowed to be lowered from the position shown in FIG. 6 so as to create a certain gap between it and the dam member 58, and then the substrate W is placed and fixed on the substrate holder 40a. Thereafter, the substrate holder 40a is elevated so as to seal the peripheral portion of the substrate W and form, together with the dam member 58, the plating bath 46a. The other construction of the device is the same as the device shown in FIGS. 4 and 5, and therefore an explanation thereof is omitted, using the same reference numerals.

The plated liquid once used may of course be disposed of as a waste without reusing it.

FIG. 7 shows an electroless plating device 23b according to still another embodiment of the present invention. The electroless plating device 23b includes a rotatable, vertically-movable substrate holder 40b for holding the substrate W with its front surface downward, and a plating bath 60 for holding the plating solution 50. A scrubbing member 56a, in the shape of a roll or a disk, is disposed and fixed at the bottom of the plating bath 60. The substrate holder 40b is provided with a sealing member that seals the peripheral portion of the upper surface of the substrate W when the substrate W is held on the lower surface of the substrate holder 40b. The scrubbing member 56a may be rotatable.

According to this embodiment, the substrate W held by the substrate holder 40b is lowered and immersed in the plating solution 50 in the plating bath 60. The substrate W is rotated while it is kept immersed in the plating solution 50, thereby carrying out electroless plating of the surface (lower surface) of the substrate W. The substrate W is allowed to be further lowered so as to bring the lower surface of the substrate W into contact with the scrubbing member 56a. By rotating the substrate W while it is kept in contact with the scrubbing member 56a, the entire surface of the substrate W can be scrubbed with the scrubbing member 56a.

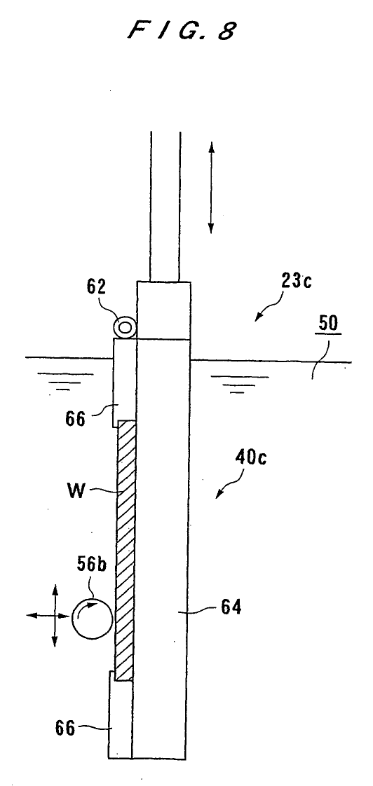

FIG. 8 shows an electroless plating device 23c according to still another embodiment of the present invention. The electroless plating device 23c includes: a vertically-movable substrate holder 40c that has a fixed base member 64 and a movable base member 66, which are openenable and closable via a hinge 62, and that holds the substrate W between the fixed base member 64 and the movable base member 66 with the peripheral portion of the substrate W being sealed; and a roll-shaped scrubbing member 56b which is rotatable and movable horizontally and vertically, and disposed in the plating solution 50 held in a plating bath.

According to this embodiment, the substrate W is held in an upright posture by the substrate holder 40c with the front surface of the substrate exposed outside, and is lowered and immersed in the plating solution 50 held in the plating bath to carry out electroless plating of the surface of the substrate W. On the other hand, the scrubbing member 56b is allowed to move toward the substrate W and come into contact with the substrate W. While kept in contact with the substrate W, the scrubbing member 56b is rotated and, at the same time, moved up and down, whereby the entire surface of the substrate W can be scrubbed with the scrubbing member 56b.

FIG. 11 shows a substrate processing apparatus according to another embodiment of the present invention. The substrate processing apparatus is provided with etching devices 162 beside the polishing devices 10a and 10b. Thus, the two first cleaning devices 20a and 20b of FIG. 2 are replaced, in this embodiment, with the etching devices 162. However, in some cases, for example in a case where the etching time is less than half of the polishing time, one etching device for two polishing devices 10a and 10b will suffice. In this case, therefore, only one of the first cleaning devices may be replaced with the etching device.

The etching device 162 includes a substrate processing section 164 for carrying out an etching treatment and its supplementary treatments, and an electrode head 168 which is supported on the end of a swingable arm 166 and swings between the substrate processing section 164 and a retreat position.

A description will now be given of a series of treatments as performed by this substrate processing apparatus. The substrate W, which has undergone the polishing (rough polishing) in the polishing device 10a or 10b, is moved to the pusher 36 by the swing of the top ring 28, where the substrate W is spray-cleaned. Thereafter, the substrate W is transferred by the second robot 14b to the wet substrate-reversing machine 18, where the substrate W is reversed so that the surface of the substrate, to be treated, faces upward. The reversed substrate W is transferred by the second robot 14b to the etching device 162 and received by the substrate holder 164 in its substrate transfer position. The substrate holder 164 holds the substrate W by a chuck mechanism.

The substrate W is subjected to finish polishing, e.g. by electrolytic etching, in the etching device 162. After the etching, the substrate W is cleaned, and then transferred to the second robot 14b. The substrate W is transferred to the cleaning device 22 for first cleaning and drying, and the cleaned substrate W is taken by the first robot 14a. The substrate w is then transferred to the electroless plating device 23. In the electroless plating device 23, electroless Ni—B plating, for example, is carried out to the polished surface of the substrate W to thereby form, as shown in FIG. 1C, the protective film (plated film) 9 of a Ni—B alloy selectively on the exposed surface of copper interconnects 8 to protect the interconnects 8. Thereafter, the substrate W is returned to the cassette 12a or 12b of the loading/unloading section.

According to this embodiment, the polishing (rough polishing) in the CMP device 10a or 10b and the etching treating (finish polishing) in the etching device 26 can be performed in parallel, thus at a high utilization rate of the devices. This makes it possible to carry out the etching treatment for a long time, thereby sufficiently removing unnecessary matter on the surface of the substrate and providing a high-quality processed substrate.

The following Examples illustrate the present invention but are not intended to limit it.

### EXAMPLE 1

First, a plating solution was prepared by using, as shown in Table 1 below, 0.02 M of NiSO₄.6H₂O as a supply source of divalent nickel ions, 0.02M of DL-malic acid and 0.03 M of glycine as complexing agents for nickel ions, and 0.02 M of DMAH (dimethylamine borane) as a reducing agent for nickel ions, and by adjusting the pH of the plating solution to 5-12 by the use of TMAH (tetramethylammonium hydroxide).

TABLE 1

| | Plating solution |
|---|---|
| NiSO₄.6H₂O | 0.02 M |
| DMAB | 0.02 M |
| DL-malic acid | 0.02 M |
| Glycine | 0.03 M |
| pH | pH = 5-12 with TMAH |
| Temperature | 60° C. |

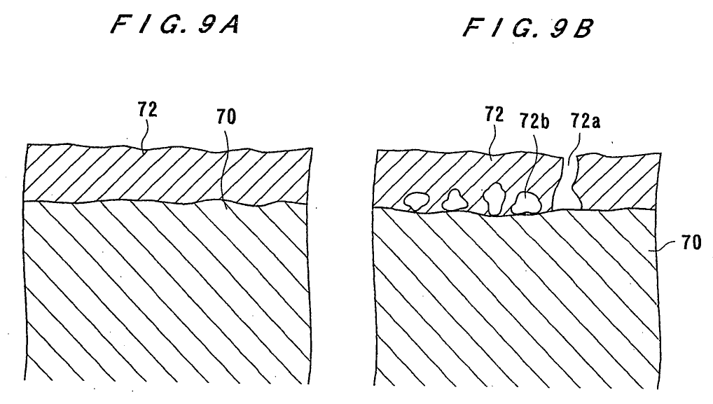

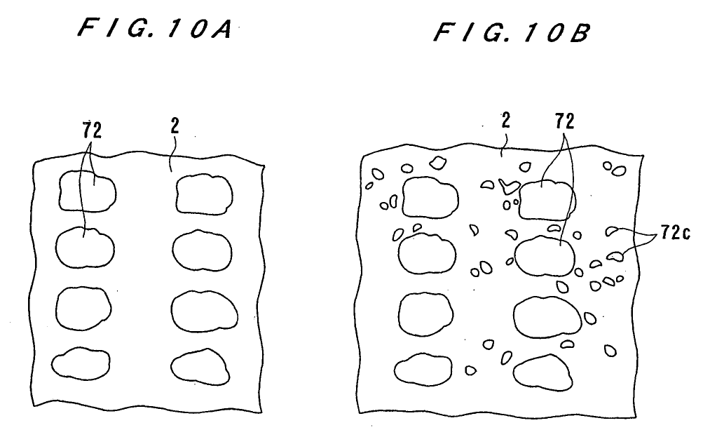

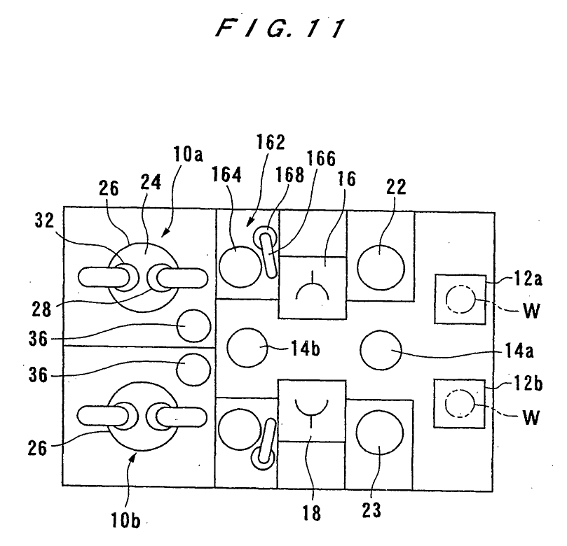

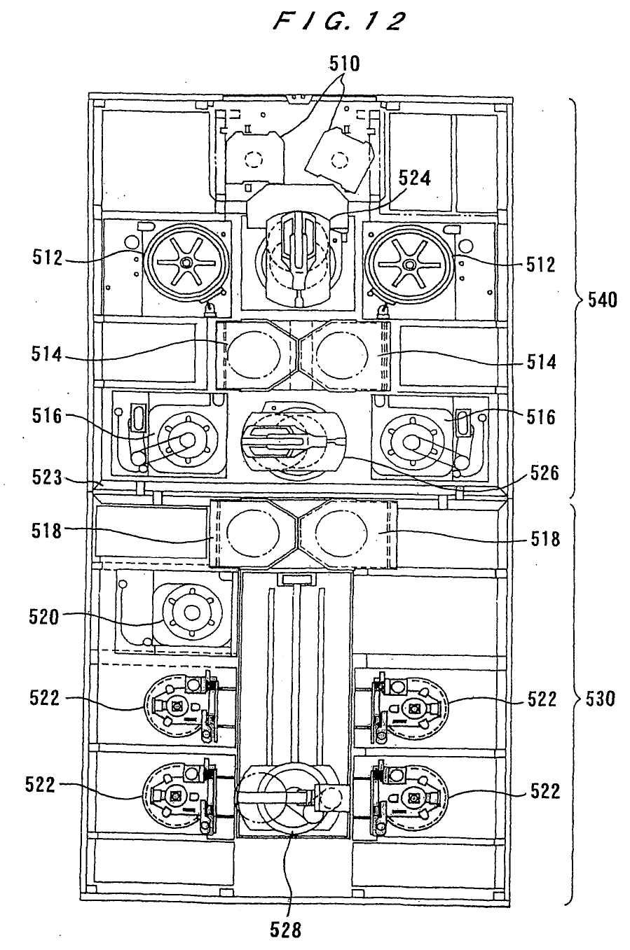

A substrate W having a copper surface layer was subjected to electroless plating using the above plating solution as the plating solution 50 used in the electroless plating device 23 shown in FIGS. 4 and 5, thereby depositing a Ni—B alloy film having a thickness of about 74 nm on the copper layer. The electroless plating was first carried without scrubbing of the substrate for 0.5 minute; the plating was continued while scrubbing the surface of the substrate W with the scrubbing member 56 at a rate of one reciprocation in 15 seconds. FIG. 9A shows a diagram of an SEM (scanning electron microscope) photograph of the plated substrate. As a comparative test, the electroless plating was carried out without scrubbing the surface of the substrate W throughout the plating to deposit a Ni—B alloy film having a thickness of about 74 nm on the copper layer. FIG. 9B shows a diagram of an SEM photograph of the plated substrate (comparative sample). In FIGS. 9A and 9B, reference numeral 70 denotes the copper layer and 72 denotes the Ni—B alloy film.

As can be seen from FIG. 9A, there was no formation of voids or pores in the Ni—B alloy film 72 of the plated substrate sample prepared according to the present invention, whereas in the comparative sample, as shown in FIG. 9B, fine pores 72a, penetrating the film in the thickness direction, and voids 72b were formed in the Ni—B alloy film 72.

### EXAMPLE 2

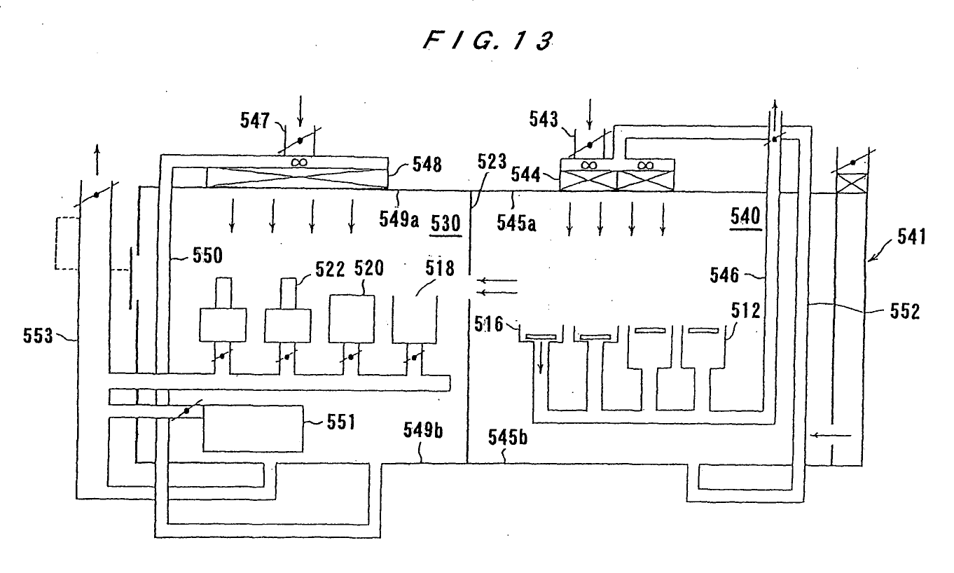

A substrate W which had been prepared by filling holes each having a diameter of 0.5 μm formed in a surface layer of an SiO₂ insulating film with copper, followed by polishing of the surface of the substrate, was subjected to electroless plating for two minutes using the same plating solution as used in Example 1 (having the composition of Table 1) as the plating solution 50 used in the electroless plating device 23 shown in FIGS. 4 and 5. The electroless plating was first carried out without scrubbing of the substrate for 0.5 minutes; the plating was continued for a further 1.5 minutes while scrubbing the surface of the substrate W with the scrubbing member 56 at a rate of one reciprocation in 15 seconds. FIG. 10A shows a diagram of an SEM photograph of the plated substrate. As a comparative test, the electroless plating was carried out for 2 minutes without scrubbing the surface of the substrate W throughout the plating. FIG. 10B shows a diagram of an SEM photograph of the plated substrate (comparative sample). In FIGS. 10A and 10B, reference numeral 2 denotes the insulating film, and 72 denotes the plated Ni—B alloy film.

As is apparent from FIG. 10A, in the plated substrate sample prepared according to the present invention, there was no deposition of Ni—B alloy film on the unnecessary portion, i.e. the portion of insulting film 2, of the surface of the substrate, thus indicating good selectivity; whereas in the case of the comparative sample, as shown in FIG. 10B, Ni—B alloy film 72c was deposited on the unnecessary portion around the holes (filled with copper), indicating poor selectivity. As a result of measurement, the uniformity in film thickness (1σ) of the Ni—B alloy film 72 was 12.0% for the test sample according to the present invention and 24.9% for the comparative sample, indicating improved uniformity of the former.

As described hereinabove, according to the electroless plating method and device of the present invention, by scrubbing the surface of a plated film with a scrubbing member in the course of the growth of the film, H₂ gas generated upon the film formation is forced to be expelled, whereby the H₂ gas is prevented from being taken in the plated film, and the formation of fine pores in the plated film can be prevented. Further, by stirring with the scrubbing member a plating solution present in the vicinity of the surface of a substrate, the uniformity in film thickness of the plated film can be improved. Moreover, by scrubbing the plated film with the scrubbing member, the plated film adhering to the unnecessary (non-interconnect) portion of the surface of the substrate can be removed, whereby the selectivity can be enhanced.

Further, according to the substrate processing method and apparatus of the present invention, electroless plating of the surface of a substrate having interconnects can be carried out immediately after polishing of the surface of the substrate, i.e. when the interconnects are little oxidized, whereby a protective film (plated film) in a stable state (good adhesion to the interconnects) can be obtained and the surface of the substrate can be protected stably with the protective film. The present invention can provide such a high-quality product at a low cost.

FIG. 12 is a plan view of an example of a substrate plating apparatus. The substrate plating apparatus comprises loading/unloading sections 510, each pair of cleaning/drying sections 512, first substrate stages 514, bevel-etching/chemical cleaning sections 516 and second substrate stages 518, a washing section 520 provided with a mechanism for reversing the substrate through 180°, and four plating apparatuses 522. The plating substrate apparatus is also provided with a first transferring device 524 for transferring a substrate between the loading/unloading sections 510, the cleaning/drying sections 512 and the first substrate stages 514, a second transferring device 526 for transferring a substrate between the first substrate stages 514, the bevel-etching/chemical cleaning sections 516 and the second substrate stages 518, and a third transferring device 528 for transferring the substrate between the second substrate stages 518, the washing section 520 and the plating apparatuses 522.

The substrate plating apparatus has a partition wall 523 for dividing the plating apparatus into a plating space 530 and a clean space 540. Air can individually be supplied into and exhausted from each of the plating space 530 and the clean space 540. The partition wall 523 has a shutter (not shown) capable of opening and closing. The pressure of the clean space 540 is lower than the atmospheric pressure and higher than the pressure of the plating space 530. This can prevent the air in the clean space 540 from flowing out of the plating apparatus and can prevent the air in the plating space 530 from flowing into the clean space 540.

FIG. 13 is a schematic view showing an air current in the plating substrate apparatus. In the clean space 540, a fresh external air is introduced through a pipe 543 and pushed into the clean space 540 through a high-performance filter 544 by a fan. Hence, a down-flow clean air is supplied from a ceiling 545a to positions around the cleaning/drying sections 512 and the bevel-etching/chemical cleaning sections 516. A large part of the supplied clean air is returned from a floor 545b through a circulation pipe 552 to the ceiling 545a, and pushed again into the clean space 540 through the high-performance filter 544 by the fan, to thus circulate in the clean space 540. A part of the air is discharged from the cleaning/drying sections 512 and the bevel-etching/chemical cleaning sections 516 through a pipe 546 to the exterior, so that the pressure of the clean space 540 is set to be lower than the atmospheric pressure.

The plating space 530 having the washing sections 520 and the plating apparatuses 522 therein is not a clean space (but a contamination zone). However, it is not acceptable to attach particles to the surface of the substrate. Therefore, in the plating space 530, a fresh external air is introduced through a pipe 547, and a down-flow clean air is pushed into the plating space 530 through a high-performance filter 548 by a fan, for thereby preventing particles from being attached to the surface of the substrate. However, if the whole flow rate of the down-flow clean air is supplied by only an external air supply and exhaust, then enormous air supply and exhaust are required. Therefore, the air is discharged through a pipe 553 to the exterior, and a large part of the down-flow is supplied by a circulating air through a circulation pipe 550 extended from a floor 549b, in such a state that the pressure of the plating space 530 is maintained to be lower than the pressure of the clean space 540.

Thus, the air returned to a ceiling 549a through the circulation pipe 550 is pushed again into the plating space 530 through the high-performance filter 548 by the fan. Hence, a clean air is supplied into the plating space 530 to thus circulate in the plating space 530. In this case, air containing chemical mist or gas emitted from the washing section 520, the plating apparatuses 522, the third transferring device 528, and a plating solution regulating bath 551 is discharged through the pipe 553 to the exterior. Thus, the pressure of the plating space 530 is controlled so as to be lower than the pressure of the clean space 540.

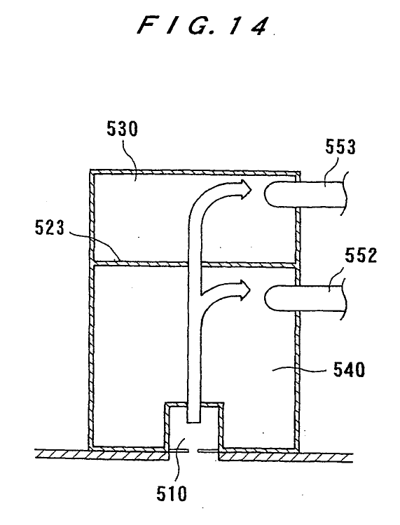

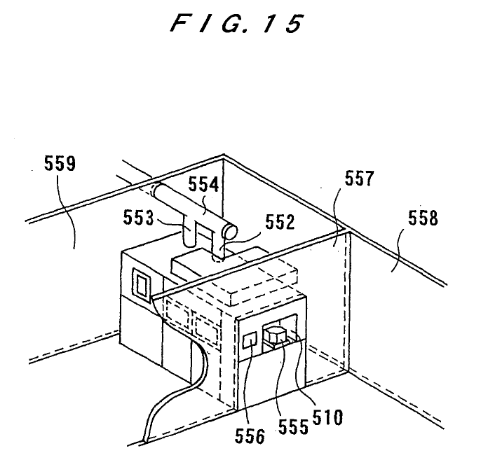

The pressure in the loading/unloading sections 510 is higher than the pressure in the clean space 540 which is higher than the pressure in the plating space 530. When the shutters (not shown) are opened, therefore, air flows successively through the loading/unloading sections 510, the clean space 540, and the plating space 530, as shown in FIG. 14. Air discharged from the clean space 540 and the plating space 530 flows through the ducts 552, 553 into a common duct 554 (see FIG. 15) which extends out of the clean room.

FIG. 15 shows in perspective the substrate plating apparatus shown in FIG. 12, which is placed in the clean room. The loading/unloading sections 510 includes a side wall which has a cassette transfer port 555 defined therein and a control panel 556, and which is exposed to a working zone 558 that is compartmented in the clean room by a partition wall 557. The partition wall 557 also compartments a utility zone 559 in the clean room in which the substrate plating apparatus is installed. Other sidewalls of the substrate plating apparatus are exposed to the utility zone 559 whose air cleanness is lower than the air cleanness in the working zone 558.

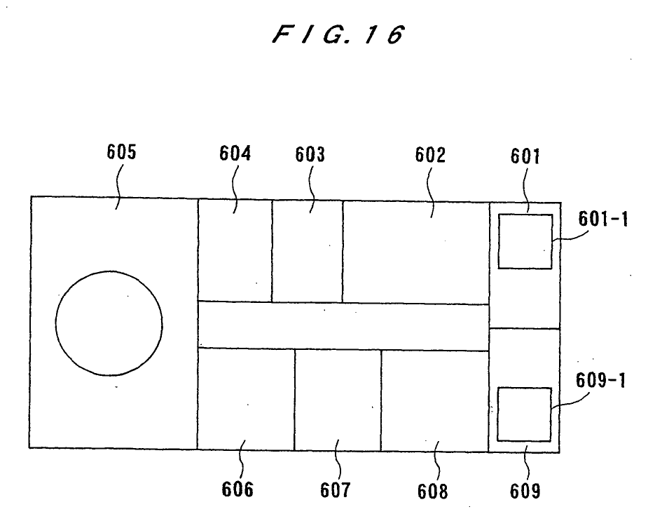

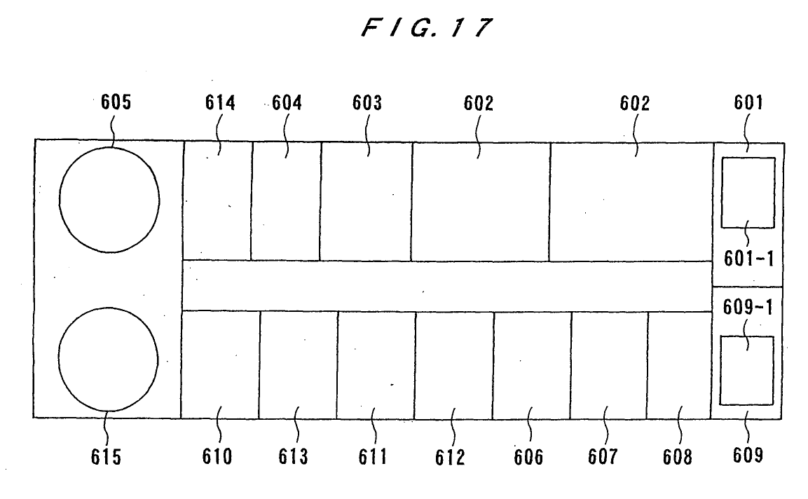

FIG. 16 is a plan view of another example of a substrate plating apparatus. The substrate plating apparatus shown in FIG. 16 comprises a loading unit 601 for loading a semiconductor substrate, a copper plating chamber 602 for plating a semiconductor substrate with copper, a pair of water cleaning chambers 603, 604 for cleaning a semiconductor substrate with water, a chemical mechanical polishing unit 605 for chemically and mechanically polishing a semiconductor substrate, a pair of water cleaning chambers 606, 607 for cleaning a semiconductor substrate with water, a drying chamber 608 for drying a semiconductor substrate, and an unloading unit 609 for unloading a semiconductor substrate with an interconnection film thereon. The substrate plating apparatus also has a substrate transfer mechanism (not shown) for transferring semiconductor substrates to the chambers 602, 603, 604, the chemical mechanical polishing unit 605, the chambers 606, 607, 608, and the unloading unit 609. The loading unit 601, the chambers 602, 603, 604, the chemical mechanical polishing unit 605, the chambers 606, 607, 608, and the unloading unit 609 are combined into a single unitary arrangement as an apparatus.

The substrate plating apparatus operates as follows:

The substrate transfer mechanism transfers a semiconductor substrate W on which an interconnection film has not yet been formed from a substrate cassette 601-1 placed in the loading unit 601 to the copper plating chamber 602. In the copper plating chamber 602, a plated copper film is formed on a surface of the semiconductor substrate W having an interconnection region composed of an interconnection trench and an interconnection hole (contact hole).

After the plated copper film is formed on the semiconductor substrate W in the copper plating chamber 602, the semiconductor substrate W is transferred to one of the water cleaning chambers 603, 604 by the substrate transfer mechanism and cleaned by water in one of the water cleaning chambers 603, 604. The cleaned semiconductor substrate W is transferred to the chemical mechanical polishing unit 605 by the substrate transfer mechanism. The chemical mechanical polishing unit 605 removes the unwanted plated copper film from the surface of the semiconductor substrate W, leaving a portion of the plated copper film in the interconnection trench and the interconnection hole. A barrier layer made of TiN or the like is formed on the surface of the semiconductor substrate W, including the inner surfaces of the interconnection trench and the interconnection hole, before the plated copper film is deposited.

Then, the semiconductor substrate W with the remaining plated copper film is transferred to one of the water cleaning chambers 606, 607 by the substrate transfer mechanism and cleaned by water in one of the water cleaning chambers 606, 607. The cleaned semiconductor substrate W is then dried in the drying chamber 608, after which the dried semiconductor substrate W with the remaining plated copper film serving as an interconnection film is placed into a substrate cassette 609-1 in the unloading unit 609.

FIG. 17 shows a plan view of still another example of a substrate plating apparatus. The substrate plating apparatus shown in FIG. 17 differs from the substrate plating apparatus shown in FIG. 16 in that it additionally includes a copper plating chamber 602, a water cleaning chamber 610, a pretreatment chamber 611, a protective film plating chamber 612 for forming a protective film on a plated copper film on a semiconductor substrate, water cleaning chamber 613, 614, and a chemical mechanical polishing unit 615. The loading unit 601, the chambers 602, 602, 603, 604, 614, the chemical mechanical polishing unit 605, 615, the chambers 606, 607, 608, 610, 611, 612, 613, and the unloading unit 609 are combined into a single unitary arrangement as an apparatus.

The substrate plating apparatus shown in FIG. 17 operates as follows:

A semiconductor substrate W is supplied from the substrate cassette 601-1 placed in the loading unit 601 successively to one of the copper plating chambers 602, 602. In one of the copper plating chamber 602, 602, a plated copper film is formed on a surface of a semiconductor substrate W having an interconnection region composed of an interconnection trench and an interconnection hole (contact hole). The two copper plating chambers 602, 602 are employed to allow the semiconductor substrate W to be plated with a copper film for a long period of time. Specifically, the semiconductor substrate W may be plated with a primary copper film according to electroless plating in one of the copper plating chamber 602, and then plated with a secondary copper film according to electroplating in the other copper plating chamber 602. The substrate plating apparatus may have more than two copper plating chambers.

The semiconductor substrate W with the plated copper film formed thereon is cleaned by water in one of the water cleaning chambers 603, 604. Then, the chemical mechanical polishing unit 605 removes the unwanted portion of the plated copper film from the surface of the semiconductor substrate W, leaving a portion of the plated copper film in the interconnection trench and the interconnection hole.

Thereafter, the semiconductor substrate W with the remaining plated copper film is transferred to the water cleaning chamber 610, in which the semiconductor substrate W is cleaned with water. Then, the semiconductor substrate W is transferred to the pretreatment chamber 611, and pretreated therein for the deposition of a protective film. The pretreated semiconductor substrate W is transferred to the protective film-plating chamber 612. In the protective film plating chamber 612, a protective film is formed on the plated copper film in the interconnection region on the semiconductor substrate W. For example, the protective film is formed with an alloy of nickel (Ni) and boron (B) by electroless plating.

After semiconductor substrate is cleaned in one of the water cleaning chamber 613, 614, an upper portion of the protective film deposited on the plated copper film is polished off to planarize the protective film, in the chemical mechanical polishing unit 615,

After the protective film is polished, the semiconductor substrate W is cleaned by water in one of the water cleaning chambers 606, 607, dried in the drying chamber 608, and then transferred to the substrate cassette 609-1 in the unloading unit 609.

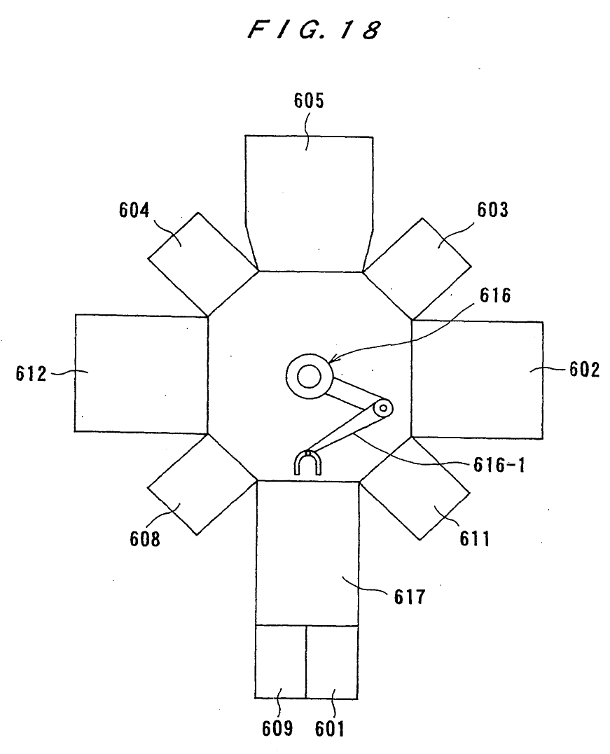

FIG. 18 is a plan view of still another example of a substrate plating apparatus. As shown in FIG. 18, the substrate plating apparatus includes a robot 616 at its center which has a robot arm 616-1, and also has a copper plating chamber 602, a pair of water cleaning chambers 603, 604, a chemical mechanical polishing unit 605, a pretreatment chamber 611, a protective film plating chamber 612, a drying chamber 608, and a loading/unloading station 617 which are disposed around the robot 616 and positioned within the reach of the robot arm 616-1. A loading unit 601 for loading semiconductor substrates and an unloading unit 609 for unloading semiconductor substrates is disposed adjacent to the loading/unloading station 617. The robot 616, the chambers 602, 603, 604, the chemical mechanical polishing unit 605, the chambers 608, 611, 612, the loading/unloading station 617, the loading unit 601, and the unloading unit 609 are combined into a single unitary arrangement as an apparatus.

The substrate plating apparatus shown in FIG. 18 operates as follows:

A semiconductor substrate to be plated is transferred from the loading unit 601 to the loading/unloading station 617, from which the semiconductor substrate is received by the robot arm 616-1 and transferred thereby to the copper plating chamber 602. In the copper plating chamber 602, a plated copper film is formed on a surface of the semiconductor substrate which has an interconnection region composed of an interconnection trench and an interconnection hole. The semiconductor substrate with the plated copper film formed thereon is transferred by the robot arm 616-1 to the chemical mechanical polishing unit 605. In the chemical mechanical polishing unit 605, the plated copper film is removed from the surface of the semiconductor substrate W, leaving a portion of the plated copper film in the interconnection trench and the interconnection hole.

The semiconductor substrate is then transferred by the robot arm 616-1 to the water-cleaning chamber 604, in which the semiconductor substrate is cleaned by water. Thereafter, the semiconductor substrate is transferred by the robot arm 616-1 to the pretreatment chamber 611, in which the semiconductor substrate is pretreated therein for the deposition of a protective film. The pretreated semiconductor substrate is transferred by the robot arm 616-1 to the protective film plating chamber 612. In the protective film plating chamber 612, a protective film is formed on the plated copper film in the interconnection region on the semiconductor substrate W. The semiconductor substrate with the protective film formed thereon is transferred by the robot arm 616-1 to the water cleaning chamber 604, in which the semiconductor substrate is cleaned by water. The cleaned semiconductor substrate is transferred by the robot arm 616-1 to the drying chamber 608, in which the semiconductor substrate is dried. The dried semiconductor substrate is transferred by the robot arm 616-1 to the loading/unloading station 617, from which the plated semiconductor substrate is transferred to the unloading unit 609.

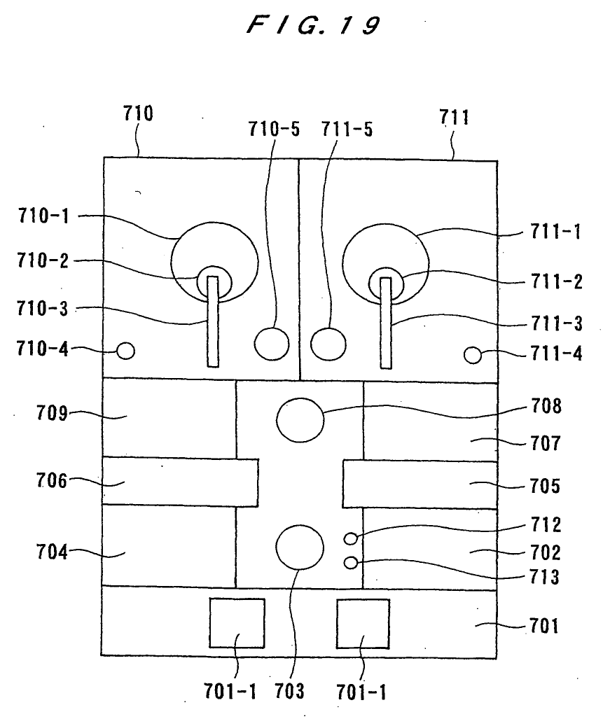

FIG. 19 is a view showing the plan constitution of another example of a semiconductor substrate processing apparatus. The semiconductor substrate processing apparatus is of a constitution in which there are provided a loading/unloading section 701, a plated Cu film forming unit 702, a first robot 703, a third cleaning machine 704, a reversing machine 705, a reversing machine 706, a second cleaning machine 707, a second robot 708, a first cleaning machine 709, a first polishing apparatus 710, and a second polishing apparatus 711. A before-plating and after-plating film thickness measuring instrument 712 for measuring the film thicknesses before and after plating, and a dry state film thickness measuring instrument 713 for measuring the film thickness of a semiconductor substrate W in a dry state after polishing are placed near the first robot 703.

The first polishing apparatus (polishing unit) 710 has a polishing table 710-1, a top ring 710-2, a top ring head 710-3, a film thickness measuring instrument 710-4, and a pusher 710-5. The second polishing apparatus (polishing unit) 711 has a polishing table 711-1, a top ring 711-2, a top ring head 711-3, a film thickness measuring instrument 711-4, and a pusher 711-5.

A cassette 701-1 accommodating the semiconductor substrates W, in which a via hole and a trench for interconnect are formed, and a seed layer is formed thereon is placed on a loading port of the loading/unloading section 701. The first robot 703 takes out the semiconductor substrate W from the cassette 701-1, and carries the semiconductor substrate W into the plated Cu film forming unit 702 where a plated Cu film is formed. At this time, the film thickness of the seed layer is measured with the before-plating and after-plating film thickness measuring instrument 712. The plated Cu film is formed by carrying out hydrophilic treatment of the face of the semiconductor substrate W, and then Cu plating. After formation of the plated Cu film, rinsing or cleaning of the semiconductor substrate W is carried out in the plated Cu film forming unit 702.

When the semiconductor substrate W is taken out from the plated Cu film forming unit 702 by the first robot 703, the film thickness of the plated Cu film is measured with the before-plating and after-plating film thickness measuring instrument 712. The results of its measurement are recorded into a recording device (not shown) as record data on the semiconductor substrate, and are used for judgment of an abnormality of the plated Cu film forming unit 702. After measurement of the film thickness, the first robot 703 transfers the semiconductor substrate W to the reversing machine 705, and the reversing machine 705 reverses the semiconductor substrate W (the surface on which the plated Cu film has been formed faces downward). The first polishing apparatus 710 and the second polishing apparatus 711 perform polishing in a serial mode and a parallel mode. Next, polishing in the serial mode will be described.

In the serial mode polishing, a primary polishing is performed by the polishing apparatus 710, and a secondary polishing is performed by the polishing apparatus 711. The second robot 708 picks up the semiconductor substrate W on the reversing machine 705, and places the semiconductor substrate W on the pusher 710-5 of the polishing apparatus 710. The top ring 710-2 attracts the semiconductor substrate W on the pusher 710-5 by suction, and brings the surface of the plated Cu film of the semiconductor substrate W into contact with a polishing surface of the polishing table 710-1 under pressure to perform a primary polishing. With the primary polishing, the plated Cu film is basically polished. The polishing surface of the polishing table 710-1 is composed of foamed polyurethane such as IC1000, or a material having abrasive grains fixed thereto or impregnated therein. Upon relative movements of the polishing surface and the semiconductor substrate W, the plated Cu film is polished.

After completion of polishing of the plated Cu film, the semiconductor substrate W is returned onto the pusher 710-5 by the top ring 710-2. The second robot 708 picks up the semiconductor substrate W, and introduces it into the first cleaning machine 709. At this time, a chemical liquid may be ejected toward the face and backside of the semiconductor substrate w on the pusher 710-5 to remove particles therefrom or cause particles to be difficult to adhere thereto.

After completion of cleaning in the first cleaning machine 709, the second robot 708 picks up the semiconductor substrate W, and places the semiconductor substrate W on the pusher 711-5 of the second polishing apparatus 711. The top ring 711-2 attracts the semiconductor substrate W on the pusher 711-5 by suction, and brings the surface of the semiconductor substrate W, which has the barrier layer formed thereon, into contact with a polishing surface of the polishing table 711-1 under pressure to perform the secondary polishing. The constitution of the polishing table is the same as the top ring 711-2. With this secondary polishing, the barrier layer is polished. However, there may be a case in which a Cu film and an oxide film left after the primary polishing are also polished.

A polishing surface of the polishing table 711-1 is composed of foamed polyurethane such as IC1000, or a material having abrasive grains fixed thereto or impregnated therein. Upon relative movements of the polishing surface and the semiconductor substrate W, polishing is carried out. At this time, silica, alumina, ceria, or the like is used as abrasive grains or slurry. A chemical liquid is adjusted depending on the type of the film to be polished.

Detection of an end point of the secondary polishing is performed by measuring the film thickness of the barrier layer mainly with the use of the optical film thickness measuring instrument, and detecting the film thickness which has become zero, or the surface of an insulating film comprising SiO₂ shows up. Furthermore, a film thickness measuring instrument with an image processing function is used as the film thickness measuring instrument 711-4 provided near the polishing table 711-1. By use of this measuring instrument, measurement of the oxide film is made, the results are stored as processing records of the semiconductor substrate W, and used for judging whether the semiconductor substrate W in which secondary polishing has been finished can be transferred to a subsequent step or not. If the end point of the secondary polishing is not reached, re-polishing is performed. If over-polishing has been performed beyond a prescribed value due to any abnormality, then the semiconductor substrate processing apparatus is stopped to avoid next polishing so that defective products will not increase.

After completion of the secondary polishing, the semiconductor substrate W is moved to the pusher 711-5 by the top ring 711-2. The second robot 708 picks up the semiconductor substrate W on the pusher 711-5. At this time, a chemical liquid may be ejected toward the face and backside of the semiconductor substrate W on the pusher 711-5 to remove particles therefrom or cause particles to be difficult to adhere thereto.

The second robot 708 carries the semiconductor substrate W into the second cleaning machine 707 where cleaning of the semiconductor substrate W is performed. The constitution of the second cleaning machine 707 is also the same as the constitution of the first cleaning machine 709. The face of the semiconductor substrate W is scrubbed with the PVA sponge rolls using a cleaning liquid comprising pure water to which a surface active agent, a chelating agent, or a pH regulating agent is added. A strong chemical liquid such as DHF is ejected from a nozzle toward the backside of the semiconductor substrate W to perform etching of the diffused Cu thereon. If there is no problem of diffusion, scrubbing cleaning is performed with the PVA sponge rolls using the same chemical liquid as that used for the face.

After completion of the above cleaning, the second robot 708 picks up the semiconductor substrate W and transfers it to the reversing machine 706, and the reversing machine 706 reverses the semiconductor substrate W. The semiconductor substrate W which has been reversed is picked up by the first robot 703, and transferred to the third cleaning machine 704. In the third cleaning machine 704, megasonic water excited by ultrasonic vibrations is ejected toward the face of the semiconductor substrate W to clean the semiconductor substrate W. At this time, the face of the semiconductor substrate W may be cleaned with a known pencil type sponge using a cleaning liquid comprising pure water to which a surface active agent, a chelating agent, or a pH regulating agent is added. Thereafter, the semiconductor substrate W is dried by spin-drying.

As described above, if the film thickness has been measured with the film thickness measuring instrument 711-4 provided near the polishing table 711-1, then the semiconductor substrate W is not subjected to further process and is accommodated into the cassette placed on the unloading port of the loading/unloading section 701.

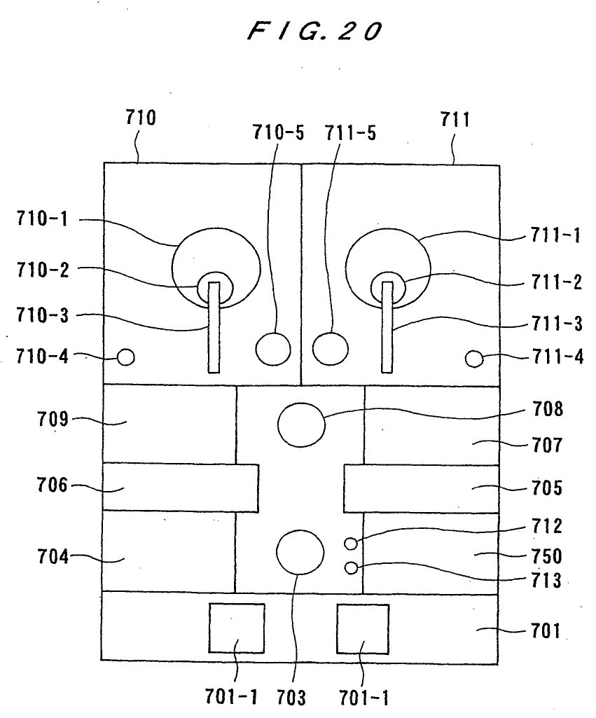

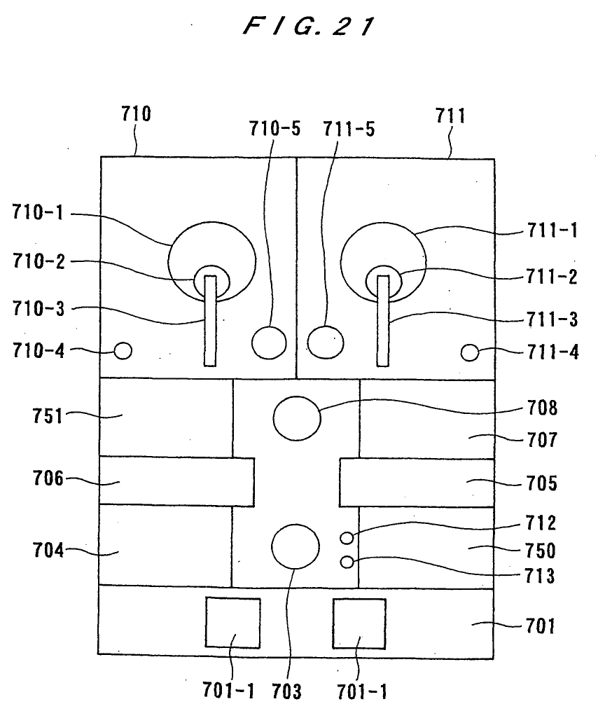

FIG. 20 is a view showing the plan constitution of another example of a semiconductor substrate processing apparatus. The substrate processing apparatus differs from the substrate processing apparatus shown in FIG. 19 in that a cap plating unit 750 is provided instead of the plated Cu film forming unit 702 in FIG. 19.

A cassette 701-1 accommodating the semiconductor substrates W formed plated Cu film is placed on a load port of a loading/unloading section 701. The semiconductor substrate W taken out from the cassette 701-1 is transferred to the first polishing apparatus 710 or second polishing apparatus 711 in which the surface of the plated Cu film is polished. After completion of polishing of the plated Cu film, the semiconductor substrate W is cleaned in the first cleaning machine 709.

After completion of cleaning in the first cleaning machine 709, the semiconductor substrate W is transferred to the cap plating unit 750 where cap plating is applied onto the surface of the plated Cu film with the aim of preventing oxidation of plated Cu film due to the atmosphere. The semiconductor substrate to which cap plating has been applied is carried by the second robot 708 from the cap plating unit 750 to the second cleaning machine 707 where it is cleaned with pure water or deionized water. The semiconductor substrate after completion of cleaning is returned into the cassette 701-1 placed on the loading/unloading section 701.

FIG. 21 is a view showing the plan constitution of still another example of a semiconductor substrate processing apparatus. The substrate processing apparatus differs from the substrate processing apparatus shown in FIG. 20 in that an annealing unit 751 is provided instead of the first cleaning machine 709 in FIG. 20.

The semiconductor substrate W, which is polished in the polishing unit 710 or 711, and cleaned in the second cleaning machine 707 described above, is transferred to the cap plating unit 750 where cap plating is applied onto the surface of the plated Cu film. The semiconductor substrate to which cap plating has been applied is carried by the second robot 708 from the cap plating unit 750 to the second cleaning machine 707 where it is cleaned.

After completion of cleaning in the second cleaning machine 707, the semiconductor substrate W is transferred to the annealing unit 751 in which the substrate is annealed, whereby the plated Cu film is alloyed so as to increase the electromigration resistance of the plated Cu film. The semiconductor substrate W to which annealing treatment has been applied is carried from the annealing unit 751 to the second cleaning machine 707 where it is cleaned with pure water or deionized water. The semiconductor substrate W after completion of cleaning is returned into the cassette 701-1 placed on the loading/unloading section 701.

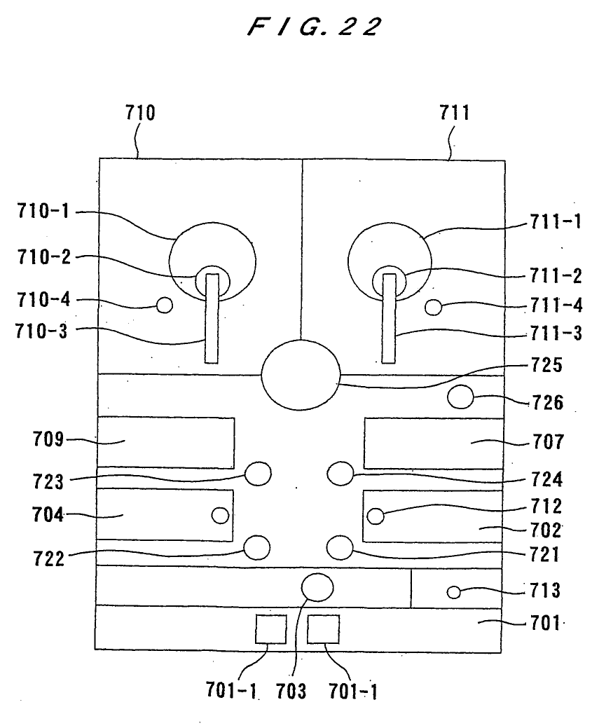

FIG. 22 is a view showing a plan layout constitution of another example of the substrate processing apparatus. In FIG. 22, portions denoted by the same reference numerals as those in FIG. 19 show the same or corresponding portions. In the substrate processing apparatus, a pusher indexer 725 is disposed close to a first polishing apparatus 710 and a second polishing apparatus 711. Substrate placing tables 721, 722 are disposed close to a third cleaning machine 704 and a plated Cu film forming unit 702, respectively. A robot 723 is disposed close to a first cleaning machine 709 and the third cleaning machine 704. Further, a robot 724 is disposed close to a second cleaning machine 707 and the plated Cu film forming unit 702, and a dry state film thickness measuring instrument 713 is disposed close to a loading/unloading section 701 and a first robot 703.

In the substrate processing apparatus of the above constitution, the first robot 703 takes out a semiconductor substrate W from a cassette 701-1 placed on the load port of the loading/unloading section 701. After the film thicknesses of a barrier layer and a seed layer are measured with the dry state film thickness measuring instrument 713, the first robot 703 places the semiconductor substrate W on the substrate placing table 721. In the case where the dry state film thickness measuring instrument 713 is provided on the hand of the first robot 703, the film thicknesses are measured thereon, and the substrate is placed on the substrate placing table 721. The second robot 723 transfers the semiconductor substrate W on the substrate placing table 721 to the plated Cu film forming unit 702 in which a plated Cu film is formed. After formation of the plated Cu film, the film thickness of the plated Cu film is measured with a before-plating and after-plating film thickness measuring instrument 712. Then, the second robot 723 transfers the semiconductor substrate W to the pusher indexer 725 and loads it thereon.

[Serial Mode]

In the serial mode, a top ring 710-2 holds the semiconductor substrate W on the pusher indexer 725 by suction, transfers it to a polishing table 710-1, and presses the semiconductor substrate W against a polishing surface on the polishing table 710-1 to perform polishing. Detection of the end point of polishing is performed by the same method as described above. The semiconductor substrate W after completion of polishing is transferred to the pusher indexer 725 by the top ring 710-2, and loaded thereon. The second robot 723 takes out the semiconductor substrate W, and carries it into the first cleaning machine 709 for cleaning. Then, the semiconductor substrate W is transferred to the pusher indexer 725, and loaded thereon.

A top ring 711-2 holds the semiconductor substrate W on the pusher indexer 725 by suction, transfers it to a polishing table 711-1, and presses the semiconductor substrate W against a polishing surface on the polishing table 711-1 to perform polishing. Detection of the end point of polishing is performed by the same method as described above. The semiconductor substrate W after completion of polishing is transferred to the pusher indexer 725 by the top ring 711-2, and loaded thereon. The third robot 724 picks up the semiconductor substrate W, and its film thickness is measured with a film thickness measuring instrument 726. Then, the semiconductor substrate W is carried into the second cleaning machine 707 for cleaning. Thereafter, the semiconductor substrate W is carried into the third cleaning machine 704, where it is cleaned and then dried by spin-drying. Then, the semiconductor substrate W is picked up by the third robot 724, and placed on the substrate placing table 722.

[Parallel Mode]

In the parallel mode, the top ring 710-2 or 711-2 holds the semiconductor substrate W on the pusher indexer 725 by suction, transfers it to the polishing table 710-1 or 711-1, and presses the semiconductor substrate W against the polishing surface on the polishing table 710-1 or 711-1 to perform polishing. After measurement of the film thickness, the third robot 724 picks up the semiconductor substrate W, and places it on the substrate placing table 722.

The first robot 703 transfers the semiconductor substrate W on the substrate placing table 722 to the dry state film thickness measuring instrument 713. After the film thickness is measured, the semiconductor substrate W is returned to the cassette 701-1 of the loading/unloading section 701.

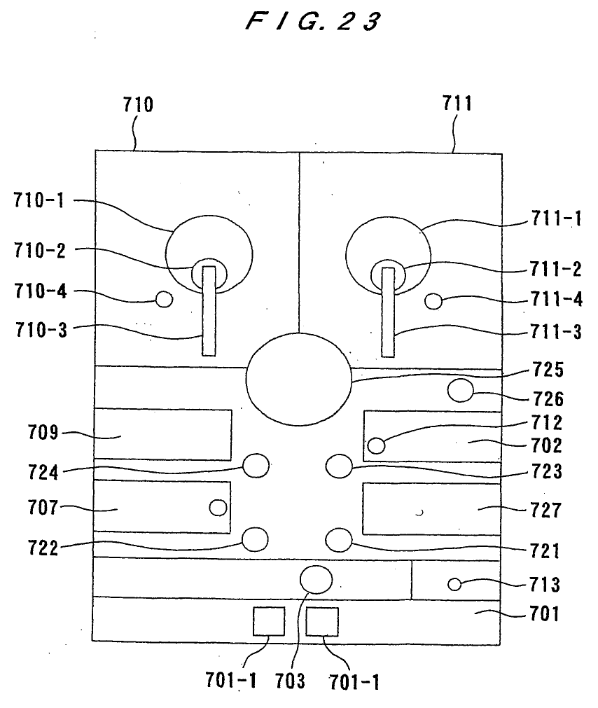

FIG. 23 is a view showing another plan layout constitution of the substrate processing apparatus. The substrate processing apparatus is such a substrate processing apparatus which forms a seed layer and a plated Cu film on a semiconductor substrate W having no seed layer formed thereon, and polishes these films to form interconnects.

In the substrate polishing apparatus, a pusher indexer 725 is disposed-close to a first polishing apparatus 710 and a second polishing apparatus 711, substrate placing tables 721, 722 are disposed close to a second cleaning machine 707 and a seed layer forming unit 727, respectively, and a robot 723 is disposed close to the seed layer forming unit 727 and a plated Cu film forming unit 702. Further, a robot 724 is disposed close to a first cleaning machine 709 and the second cleaning machine 707, and a dry state film thickness measuring instrument 713 is disposed close to a loading/unloading section 701 and a first robot 703.

The first robot 703 takes out a semiconductor substrate W having a barrier layer thereon from a cassette 701-1 placed on the load port of the loading/unloading section 701, and places it on the substrate placing table 721. Then, the second robot 723 transfers the semiconductor substrate W to the seed layer forming unit 727 where a seed layer is formed. The seed layer is formed by electroless plating. The second robot 723 enables the semiconductor substrate having the seed layer formed thereon to be measured in thickness of the seed layer by the before-plating and after-plating film thickness measuring instrument 712. After measurement of the film thickness, the semiconductor substrate is carried into the plated Cu film forming unit 702 where a plated Cu film is formed.

After formation of the plated Cu film, its film thickness is measured, and the semiconductor substrate is transferred to a pusher indexer 725. A top ring 710-2 or 711-2 holds the semiconductor substrate W on the pusher indexer 725 by suction, and transfers it to a polishing table 710-1 or 711-1 to perform polishing. After polishing, the top ring 710-2 or 711-2 transfers the semiconductor substrate W to a film thickness measuring instrument 710-4 or 711-4 to measure the film thickness. Then, the top ring 710-2 or 711-2 transfers the semiconductor substrate W to the pusher indexer 725, and places it thereon.

Then, the third robot 724 picks up the semiconductor substrate W from the pusher indexer 725, and carries it into the first cleaning machine 709. The third robot 724 picks up the cleaned semiconductor substrate W from the first cleaning machine 709, carries it into the second cleaning machine 707, and places the cleaned and dried semiconductor substrate on the substrate placing table 722. Then, the first robot 703 picks up the semiconductor substrate W, and transfers it to the dry state film thickness measuring instrument 713 in which the film thickness is measured, and the first robot 703 carries it into the cassette 701-1 placed on the unload port of the loading/unloading section 701.

In the substrate processing apparatus shown in FIG. 23, interconnects are formed by forming a barrier layer, a seed layer and a plated Cu film on a semiconductor substrate W having a via hole or a trench of a circuit pattern formed therein, and polishing them.

The cassette 701-1 accommodating the semiconductor substrates W before formation of the barrier layer is placed on the load port of the loading/unloading section 701. The first robot 703 takes out the semiconductor substrate W from the cassette 701-1 placed on the load port of the loading/unloading section 701, and places it on the substrate placing table 721. Then, the second robot 723 transfers the semiconductor substrate W to the seed layer forming unit 727 where a barrier layer and a seed layer are formed. The barrier layer and the seed layer are formed by electroless plating. The second robot 723 brings the semiconductor substrate W having the barrier layer and the seed layer formed thereon to the before-plating and after-plating film thickness measuring instrument 712 which measures the film thicknesses of the barrier layer and the seed layer. After measurement of the film thicknesses, the semiconductor substrate W is carried into the plated Cu film forming unit 702 where a plated Cu film is formed.

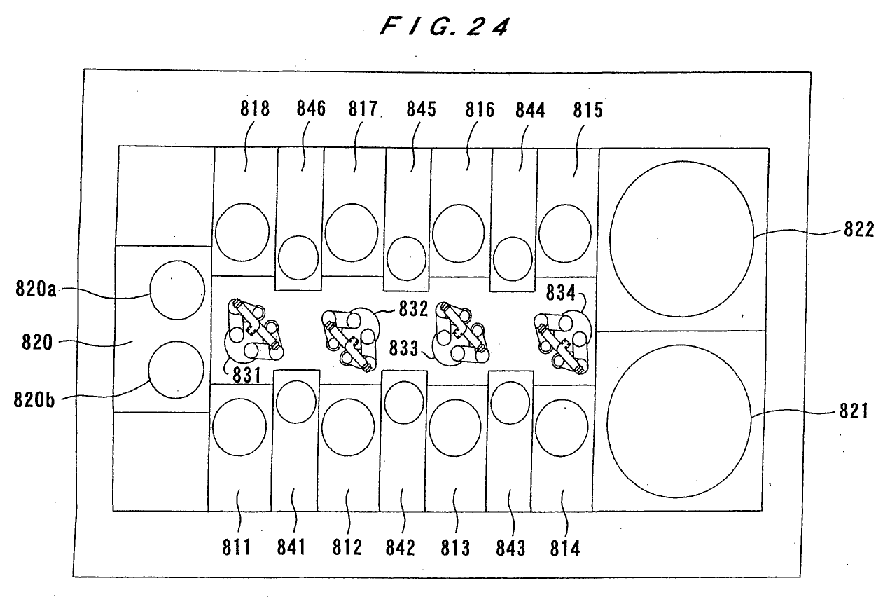

FIG. 24 is a view showing plan layout constitution of another example of the substrate processing apparatus. In the substrate processing apparatus, there are provided a barrier layer forming unit 811, a seed layer forming unit 812, a plated film forming unit 813, an annealing unit 814, a first cleaning unit 815, a bevel and backside cleaning unit 816, a cap plating unit 817, a second cleaning unit 818, a first aligner and film thickness measuring instrument 841, a second aligner and film thickness measuring instrument 842, a first substrate reversing machine 843, a second substrate reversing machine 844, a substrate temporary placing table 845, a third film thickness measuring instrument 846, a loading/unloading section 820, a first polishing apparatus 821, a second polishing apparatus 822, a first robot 831, a second robot 832, a third robot 833, and a fourth robot 834. The film thickness measuring instruments 841, 842, and 846 are units, have the same size as the frontage dimension of other units (plating, cleaning, annealing units, and the like), and are thus interchangeable.

In this example, an electroless Ru plating apparatus can be used as the barrier layer forming unit 811, an electroless Cu plating apparatus as the seed layer forming unit 812, and an electroplating apparatus as the plated film forming unit 813.

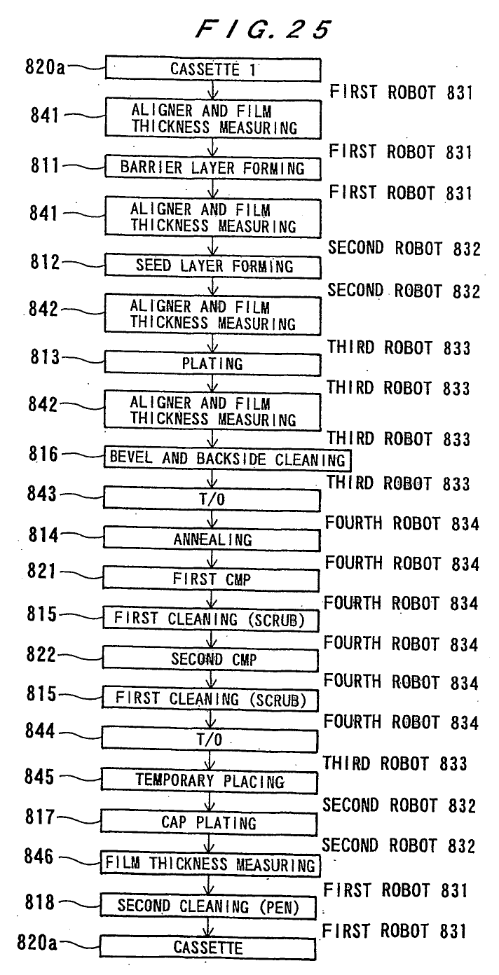

FIG. 25 is a flow chart showing the flow of the respective steps in the present substrate processing apparatus. The respective steps in the apparatus will be described according to this flow chart. First, a semiconductor substrate taken out by the first robot 831 from a cassette 820a placed on the load and unload section 820 is placed in the first aligner and film thickness measuring instrument 841, in such a state that its surface, to be plated, faces upward. In order to set a reference point for a position at which film thickness measurement is made, notch alignment for film thickness measurement is performed, and then film thickness data on the semiconductor substrate before formation of a Cu film are obtained.

Then, the semiconductor substrate is transferred to the barrier layer forming unit 811 by the first robot 831. The barrier layer forming unit 811 is such an apparatus for forming a barrier layer on the semiconductor substrate by electroless Ru plating, and the barrier layer forming unit 811 forms an Ru film as a film for preventing Cu from diffusing into an interlayer insulator film (e.g. SiO₂) of a semiconductor device. The semiconductor substrate discharged after cleaning and drying steps is transferred by the first robot 831 to the first aligner and film thickness measuring instrument 841, where the film thickness of the semiconductor substrate, i.e., the film thickness of the barrier layer is measured.

The semiconductor substrate after film thickness measurement is carried into the seed layer forming unit 812 by the second robot 832, and a seed layer is formed on the barrier layer by electroless Cu plating. The semiconductor substrate discharged after cleaning and drying steps is transferred by the second robot 832 to the second aligner and film thickness measuring instrument 842 for determination of a notch position, before the semiconductor substrate is transferred to the plated film forming unit 813, which is an impregnation plating unit, and then notch alignment for Cu plating is performed by the film thickness measuring instrument 842. If necessary, the film thickness of the semiconductor substrate before formation of a Cu film may be measured again in the film thickness measuring instrument 842.

The semiconductor substrate which has completed notch alignment is transferred by the third robot 833 to the plated film forming unit 813 where Cu plating is applied to the semiconductor substrate. The semiconductor substrate discharged after cleaning and drying steps is transferred by the third robot 833 to the bevel and backside cleaning unit 816 where an unnecessary Cu film (seed layer) at a peripheral portion of the semiconductor substrate is removed. In the bevel and backside cleaning unit 816, the bevel is etched in a preset time, and Cu adhering to the backside of the semiconductor substrate is cleaned with a chemical liquid such as hydrofluoric acid. At this time, before transferring the semiconductor substrate to the bevel and backside cleaning unit 816, film thickness measurement of the semiconductor substrate may be made by the second aligner and film thickness measuring instrument 842 to obtain the thickness value of the Cu film formed by plating, and based on the obtained results, the bevel etching time may be changed arbitrarily to carry out etching. The region etched by bevel etching is a region which corresponds to a peripheral edge portion of the substrate and has no circuit formed therein, or a region which is not utilized finally as a chip although a circuit is formed. A bevel portion is included in this region.

The semiconductor substrate discharged after cleaning and drying steps in the bevel and backside cleaning unit 816 is transferred by the third robot 833 to the substrate reversing machine 843. After the semiconductor substrate is turned over by the substrate reversing machine 843 to cause the plated surface to be directed downward, the semiconductor substrate is introduced into the annealing unit 814 by the fourth robot 834 for thereby stabilizing a interconnection portion. Before and/or after annealing treatment, the semiconductor substrate is carried into the second aligner and film thickness measuring instrument 842 where the film thickness of a copper film formed on the semiconductor substrate is measured. Then, the semiconductor substrate is carried by the fourth robot 834 into the first polishing apparatus 821 in which the Cu film and the seed layer of the semiconductor substrate are polished.

At this time, desired abrasive grains or the like are used, but fixed abrasive may be used in order to prevent dishing and enhance flatness of the face. After completion of primary polishing, the semiconductor substrate is transferred by the fourth robot 834 to the first cleaning unit 815 where it is cleaned. This cleaning is scrub-cleaning in which rolls having substantially the same length as the diameter of the semiconductor substrate are placed on the face and the backside of the semiconductor substrate, and the semiconductor substrate and the rolls are rotated, while pure water or deionized water is flowed, thereby performing cleaning of the semiconductor substrate.

After completion of the primary cleaning, the semiconductor substrate is transferred by the fourth robot 834 to the second polishing apparatus 822 where the barrier layer on the semiconductor substrate is polished. At this time, desired abrasive grains or the like are used, but fixed abrasive may be used in order to prevent dishing and enhance flatness of the face. After completion of secondary polishing, the semiconductor substrate is transferred by the fourth robot 834 again to the first cleaning unit 815 where scrub-cleaning is performed. After completion of cleaning, the semiconductor substrate is transferred by the fourth robot 834 to the second substrate reversing machine 844 where the semiconductor substrate is reversed to cause the plated surface to be directed upward, and then the semiconductor substrate is placed on the substrate temporary placing table 845 by the third robot.

The semiconductor substrate is transferred by the second robot 832 from the substrate temporary placing table 845 to the cap plating unit 817 where cap plating is applied onto the Cu surface with the aim of preventing oxidation of Cu due to the atmosphere. The semiconductor substrate to which cap plating has been applied is carried by the second robot 832 from the cap plating unit 817 to the third film thickness measuring instrument 846 where the thickness of the copper film is measured. Thereafter, the semiconductor substrate is carried by the first robot 831 into the second cleaning unit 818 where it is cleaned with pure water or deionized water. The semiconductor substrate after completion of cleaning is returned into the cassette 820a placed on the loading/unloading section 820.

The aligner and film thickness measuring instrument 841 and the aligner and film thickness measuring instrument 842 perform positioning of the notch portion of the substrate and measurement of the film thickness.

The seed layer forming unit 812 may be omitted. In this case, a plated film may be formed on a barrier layer directly in a plated film forming unit 813.

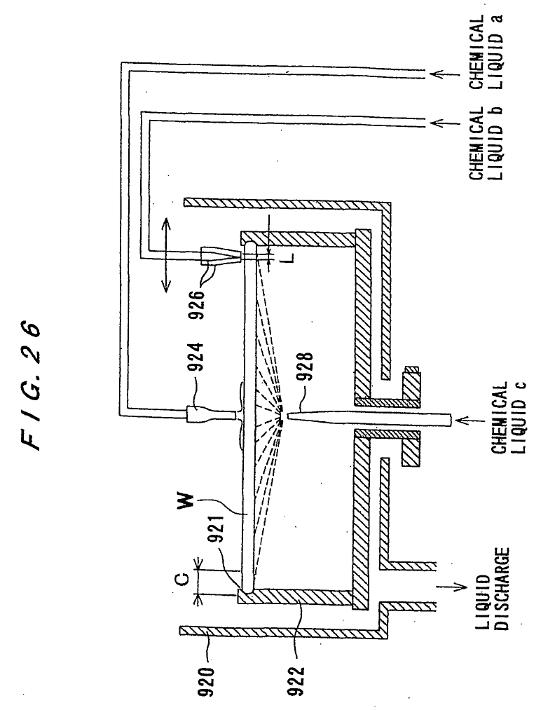

The bevel and backside cleaning unit 816 can perform an edge (bevel) Cu etching and a backside cleaning at the same time, and can suppress growth of a natural oxide film of copper at the circuit formation portion on the surface of the substrate. FIG. 26 shows a schematic view of the bevel and backside cleaning unit 816. As shown in FIG. 26, the bevel and backside cleaning unit 816 has a substrate holding portion 922 positioned inside a bottomed cylindrical waterproof cover 920 and adapted to rotate a substrate W at a high speed, in such a state that the face of the substrate W faces upwardly, while holding the substrate W horizontally by spin chucks 921 at a plurality of locations along a circumferential direction of a peripheral edge portion of the substrate, a center nozzle 924 placed above a nearly central portion of the face of the substrate W held by the substrate holding portion 922, and an edge nozzle 926 placed above the peripheral edge portion of the substrate W. The center nozzle 924 and the edge nozzle 926 are directed downward. A back nozzle 928 is positioned below a nearly central portion of the backside of the substrate W, and directed upward. The edge nozzle 926 is adapted to be movable in a diametrical direction and a height direction of the substrate W.

The width of movement L of the edge nozzle 926 is set such that the edge nozzle 926 can be arbitrarily positioned in a direction toward the center from the outer peripheral end surface of the substrate, and a set value for L is inputted according to the size, usage, or the like of the substrate W. Normally, an edge cut width C is set in the range of 2 mm to 5 mm. In the case where a rotational speed of the substrate is a certain value or higher at which the amount of liquid migration from the backside to the face is not problematic, the copper film within the edge cut width C can be removed.

Next, the method of cleaning with this cleaning apparatus will be described. First, the semiconductor substrate W is horizontally rotated integrally with the substrate holding portion 922, with the substrate being held horizontally by the spin chucks 921 of the substrate holding portion 922. In this state, an acid solution is supplied from the center nozzle 924 to the central portion of the face of the substrate W. The acid solution may be a non-oxidizing acid, and hydrofluoric acid, hydrochloric acid, sulfuric acid, citric acid, oxalic acid, or the like is used. On the other hand, an oxidizing agent solution is supplied continuously or intermittently from the edge nozzle 926 to the peripheral edge portion of the substrate W. As the oxidizing agent solution, one of an aqueous solution of ozone, an aqueous solution of hydrogen peroxide, an aqueous solution of nitric acid, and an aqueous solution of sodium hypochlorite is used, or a combination of these is used.

In this manner, the copper film, or the like formed on the upper surface and end surface in the region of the peripheral edge portion C of the semiconductor substrate W is rapidly oxidized with the oxidizing agent solution, and is simultaneously etched with the acid solution supplied from the center nozzle 924 and spread on the entire face of the substrate, whereby it is dissolved and removed. By mixing the acid solution and the oxidizing agent solution at the peripheral edge portion of the substrate, a steep etching profile can be obtained, in comparison with a mixture of them which is produced in advance being supplied. At this time, the copper etching rate is determined by their concentrations. If a natural oxide film of copper is formed in the circuit-formed portion on the face of the substrate, this natural oxide is immediately removed by the acid solution spreading on the entire face of the substrate according to rotation of the substrate, and does not grow any more. After the supply of the acid solution from the center nozzle 924 is stopped, the supply of the oxidizing agent solution from the edge nozzle 926 is stopped. As a result, silicon exposed on the surface is oxidized, and deposition of copper can be suppressed.

On the other hand, an oxidizing agent solution and a silicon oxide film etching agent are supplied simultaneously or alternately from the back nozzle 928 to the central portion of the backside of the substrate. Therefore, copper or the like adhering in a metal form to the backside of the semiconductor substrate W can be oxidized with the oxidizing agent solution, together with silicon of the substrate, and can be etched and removed with the silicon oxide film etching agent. This oxidizing agent solution is preferably the same as the oxidizing agent solution supplied to the face, because the types of chemicals are decreased in number. Hydrofluoric acid can be used as the silicon oxide film etching agent, and if hydrofluoric acid is used as the acid solution on the face of the substrate, the types of chemicals can be decreased in number. Thus, if the supply of the oxidizing agent is stopped first, a hydrophobic surface is obtained. If the etching agent solution is stopped first, a water-saturated surface (a hydrophilic surface) is obtained, and thus the backside surface can be adjusted to a condition which will satisfy the requirements of a subsequent process.

In this manner, the acid solution, i.e., etching solution is supplied to the substrate to remove metal ions remaining on the surface of the substrate W. Then, pure water is supplied to replace the etching solution with pure water and remove the etching solution, and then the substrate is dried by spin-drying. In this way, removal of the copper film in the edge cut width C at the peripheral edge portion on the face of the semiconductor substrate, and removal of copper contaminants on the backside are performed simultaneously to thus allow this treatment to be completed, for example, within 80 seconds. The etching cut width of the edge can be set arbitrarily (from 2 to 5 mm), but the time required for etching does not depend on the cut width.

Annealing treatment performed before the CMP process and after plating has a favorable effect on the subsequent CMP treatment and on the electrical characteristics of interconnection. Observation of the surface of broad interconnection (unit of several micrometers) after the CMP treatment without annealing showed many defects such as microvoids, which resulted in an increase in the electrical resistance of the entire interconnection. Execution of annealing ameliorated the increase in the electrical resistance. In the presence of annealing, thin interconnection showed no voids. Thus, the degree of grain growth is presumed to be involved in these phenomena. That is, the following mechanism can be speculated:

Grain growth is difficult to occur in thin interconnection. In broad interconnection, on the other hand, grain growth proceeds in accordance with annealing treatment. During the process of grain growth, ultra-fine pores in the plated film, which are too small to be seen by the SEM (scanning electron microscope), gather and move upward, thus forming microvoid-like depressions in the upper part of the interconnection. The annealing conditions in the annealing unit 814 are such that hydrogen (2% or less) is added in a gas atmosphere, the temperature is in the range of 300° C. to 400° C., and the time is in the range of 1 to 5 minutes. Under these conditions, the above effects were obtained.

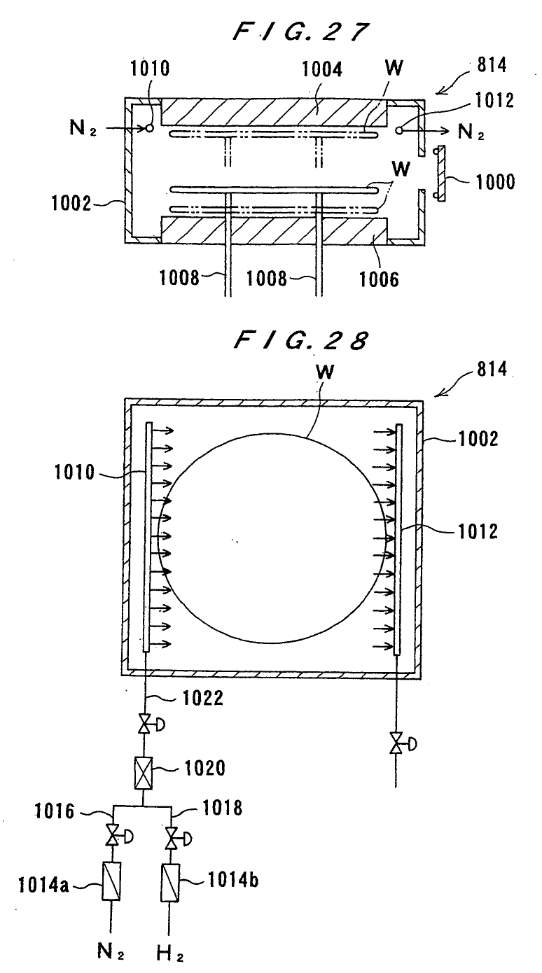

FIGS. 27 and 28 show the annealing unit 814. The annealing unit 814 comprises a chamber 1002 having a gate 1000 for taking in and taking out the semiconductor substrate W, a hot plate 1004 disposed at an upper position in the chamber 1002 for heating the semiconductor substrate W to e.g. 400° C., and a cool plate 1006 disposed at a lower position in the chamber 1002 for cooling the semiconductor substrate W by, for example, flowing a cooling water inside the plate. The annealing unit 814 also has a plurality of vertically movable elevating pins 1008 penetrating the cool plate 1006 and extending upward and downward therethrough for placing and holding the semiconductor substrate W on them. The annealing unit further includes a gas introduction pipe 1010 for introducing an antioxidant gas between the semiconductor substrate W and the hot plate 1004 during annealing, and a gas discharge pipe 1012 for discharging the gas which has been introduced from the gas introduction pipe 1010 and flowed between the semiconductor substrate W and the hot plate 1004. The pipes 1010 and 1012 are disposed on the opposite sides of the hot plate 1004.

The gas introduction pipe 1010 is connected to a mixed gas introduction line 1022 which in turn is connected to a mixer 1020 where a N₂ gas introduced through a N₂ gas introduction line 1016 containing a filter 1014a, and a H₂ gas introduced through a H₂ gas introduction line 1018 containing a filter 1014b, are mixed to form a mixed gas which flows through the line 1022 into the gas introduction pipe 1010.

In operation, the semiconductor substrate W, which has been carried in the chamber 1002 through the gate 1000, is held on the elevating pins 1008 and the elevating pins 1008 are raised up to a position at which the distance between the semiconductor substrate W held on the lifting pins 1008 and the hot plate 1004 becomes e.g. 0.1-1.0 mm. In this state, the semiconductor substrate W is then heated to e.g. 400° C. through the hot plate 1004 and, at the same time, the antioxidant gas is introduced from the gas introduction pipe 1010 and the gas is allowed to flow between the semiconductor substrate W and the hot plate 1004 while the gas is discharged from the gas discharge pipe 1012, thereby annealing the semiconductor substrate W while preventing its oxidation. The annealing treatment may be completed in about several tens of seconds to 60 seconds. The heating temperature of the substrate may be selected in the range of 100-600° C.

After the completion of the annealing, the elevating pins 1008 are lowered down to a position at which the distance between the semiconductor substrate W held on the elevating pins 1008 and the cool plate 1006 becomes e.g. 0-0.5 mm. In this state, by introducing a cooling water into the cool plate 1006, the semiconductor substrate W is cooled by the cool plate to a temperature of 100° C. or lower in e.g. 10-60 seconds. The cooled semiconductor substrate is sent to the next step.

A mixed gas of N₂ gas with several % of H₂ gas is used as the above antioxidant gas. However, N₂ gas may be used singly. The annealing unit may be placed in the electroplating apparatus.

Although certain preferred embodiments of the present invention have been shown and described in detail, it should be understood that various changes and modifications may be made therein without departing from the scope of the appended claims.

### INDUSTRIAL APPLICABILITY

This invention relates to an electroless plating method and device useful for forming a protective film for protecting the surface of the interconnects of an electronic device which has such an embedded interconnect structure that an electric conductor, such as silver or copper, is embedded into fine recesses for interconnects formed in the surface of a substrate such as a semiconductor substrate.

1. An electroless plating method, comprising:
bringing a substrate into contact with an electroless plating solution to form a plated film on a surface of the substrate; and
scrubbing the surface of said plated film formed or being formed on the surface of the substrate.

2. The electroless plating method according to claim 1, wherein the substrate is brought into contact with the electroless plating solution to form said plated film on the surface of the substrate while the surface of said plated film being formed on the surface of the substrate is scrubbed.

3. The electroless plating method according to claim 1, wherein the substrate is brought into contact with the electroless plating solution to form an initial plated film, and the electroless plating is continued to deposit a plated film on said initial plated film while scrubbing the surface of said plated film being deposited.

4. A electroless plating method, comprising:
bringing a substrate into contact with an electroless plating solution to form a plated film on a surface of the substrate;
scrubbing the surface of said plated film formed on the surface of the substrate; and
repeating said bringing and said scrubbing.

5. The electroless plating method according to any one of claims 1 to 4, wherein said scrubbing the surface of said plated film is carried out by means of a scrubbing member.

6. The electroless plating method according to any one of claims 1 to 4, wherein said scrubbing the surface of said plated film is carried out by crashing a fluid into the surface of said plated film.

7. The electroless plating method according to any one of claims 1 to 4, wherein said scrubbing the surface of the plated film is carried out by crashing particles mixed in a fluid against the surface of said plated film.

8. An electroless plating device, comprising:
a substrate holder for detachably holding a substrate and bringing the substrate into contact with an electroless plating solution; and
means for scrubbing the surface of the substrate which is held by said substrate holder and is in contact with the electroless plating solution.

9. The electroless plating device according to claim 8, wherein said means for scrubbing the surface of the substrate comprises a scrubbing member.

10. The electroless plating device according to claim 9, further comprising a moving mechanism for relatively moving said scrubbing member and said substrate holder.

11. A substrate processing method comprising the steps of:
polishing a surface of a substrate; and
electroless plating the polished surface of the substrate immediately after said polishing step.

12. A substrate processing apparatus, comprising:
a polishing device for polishing a surface of a substrate; and
an electroless plating device for carrying out electroless plating to selectively form a plated film as a protective film on said polished surface of the substrate.

13. The substrate processing apparatus according to claim 12, wherein said electroless plating device comprises:
a substrate holder for detachably holding a substrate and bringing the substrate into contact with an electroless plating solution; and
means for scrubbing the surface of the substrate which is held by said substrate holder and is in contact with the electroless plating solution.

14. The substrate processing apparatus according to claim 13, wherein said means for scrubbing the surface of the substrate comprises a scrubbing member.

15. The substrate processing apparatus according to claim 14, further comprising a moving mechanism for relatively moving said scrubbing member and said substrate holder.

16. The substrate processing apparatus according to any one of claims 12 to 15, further comprising an etching device for etching the surface of the substrate.

17. A substrate having a plated film, said plated film having been formed by a process comprising bringing a substrate into contact with an electroless plating solution to form a plated film while the surface of said plated film formed or being formed on a surface of the substrate is being scrubbed.
